(19) United States
(12) Patent Application Publication
(10) Pub. No.: US 2022/0024190 A1
(43) Pub. Date: Jan. 27, 2022

(54) MULTILAYER FILMS

(71) Applicant: NOVA CHEMICALS (INTERNATIONAL) S.A., Fribourg (CH)

(72) Inventors: Maryam Fereydoon, Calgary (CA); Stephen Salomons, Calgary (CA); Norman Aubee, Okotoks (CA); Shivendra Goyal, Calgary (CA); Patrick Lam, Calgary (CA)

(73) Assignee: NOVA CHEMICALS (INTERNATIONAL) S.A., Fribourg (CH)

(21) Appl. No.: 17/311,588

(22) PCT Filed: Dec. 9, 2019
(86) PCT No.: PCT/IB2019/060583

§ 371 Date: Jun. 7, 2021

Related U.S. Application Data
(60) Provisional application No. 62/781,014, filed on Dec. 18, 2018.

(51) Int. Cl. B32B 27/08; B32B 27/32; B32B 7/02; B32B 27/34; B32B 27/30

(52) U.S. Cl. CPC B32B 27/08; B32B 27/327; B32B 7/02; B32B 27/34; B32B 27/306; B32B 2553/00; B32B 2307/31; B32B 2307/412; B32B 2307/72; B32B 2307/732; B32B 2250/24

(57) ABSTRACT

Multilayer films are prepared from an ethylene interpolymer product having a density of from 0.905 to 0.914 g/cc and a melt index, I₂, of from 2.5 to 4.5 g/10 minutes, wherein the ethylene interpolymer product comprises:
(i) a first ethylene interpolymer;
(ii) a second ethylene interpolymer, and;
(iii) optionally a third ethylene interpolymer;
   and wherein the ethylene interpolymer product has a Dilution Index, Yd, of greater than 0 degrees. In an embodiment, the first ethylene interpolymer is made with a single site catalyst and the second ethylene interpolymer is made with a heterogeneous Ziegler Natta catalyst. This ethylene interpolymer product is used in the preparation of multilayer films, especially:
A) a film having from 3 to 15 layers, wherein the film has a two layer seal structure in which the primary seal layer is prepared with this ethylene interpolymer product;
B) a multilayer stretch wrap film having from 3 to 15 layers wherein at least one layer is prepared with this ethylene interpolymer product.

### TECHNICAL FIELD

A new ethylene interpolymer product having a melt index of from 2.5 to 4.5 g/10 minutes, a density of from 0.905 to 0.92 g/cc and a Dilution Index, Yd, of greater than 0 degrees and the use of that interpolymer product to prepare multilayer films.

### BACKGROUND ART

The preparation of ethylene interpolymer products having a dilution index, Yd, of greater than 0 degrees is disclosed in U.S. Pat. Nos. 10,035,906 and 9,512,282. The preparation of films from such interpolymer products is disclosed in U.S. Pat. Nos. 10,053,565 and 9,518,189.

### SUMMARY OF INVENTION

In an embodiment, there is provided:

a multilayer film having from 3 to 15 layers, said film having a two layer seal structure comprising a skin seal layer and an adjacent seal layer, wherein said skin seal layer comprises an ethylene interpolymer product having a melt index of from 2.5 to 4.5 dg/minute, wherein melt index is measured according to ASTM D 1238 (2.16 kg load and 190° C.) and a density of from 0.905 to 0.914 g/cc, wherein density is measured according to ASTM D792; wherein said ethylene interpolymer product comprises:

(I) a first ethylene interpolymer;

(II) a second ethylene interpolymer, and;

(III) optionally a third ethylene interpolymer;

wherein said first ethylene interpolymer is produced using a single site catalyst formulation comprising a component (i) defined by the formula:

(L^{A})ₐM(Pl)_{b}(Q)ₙ

wherein L^{A} is selected from the group consisting of unsubstituted cyclopentadienyl, substituted cyclopentadienyl, unsubstituted indenyl, substituted indenyl, unsubstituted fluorenyl and substituted fluorenyl;
M is a metal selected from the group consisting of titanium, hafnium and zirconium;
Pl is a phosphinimine ligand;
Q is independently selected from the group consisting of a hydrogen atom, a halogen atom, a C₁₋₁₀ hydrocarbyl radical, a C₁₋₁₀ alkoxy radical and a C₅₋₁₀ aryl oxide radical; wherein each of said hydrocarbyl, alkoxy, and aryl oxide radicals may be unsubstituted or further substituted by a halogen atom, a C₁₋₁₈ alkyl radical, a C₁₋₈ alkoxy radical, a C₆₋₁₀ aryl or aryloxy radical, an amido radical which is unsubstituted or substituted by up to two C₁₋₈ alkyl radicals or a phosphido radical which is unsubstituted or substituted by up to two C₁₋₈ alkyl radicals;
wherein a is 1; b is 1; n is 1 or 2; and (a+b+n) is equivalent to the valence of the metal M, and;
wherein said second ethylene interpolymer is produced using a first in-line Ziegler-Natta catalyst formulation;
wherein said third ethylene interpolymer is produced using said first in-line Ziegler-Natta catalyst formulation or a second in-line Ziegler-Natta catalyst formulation, and;
wherein said ethylene interpolymer product has a Dilution Index, Yd, greater than 0, and wherein said adjacent seal layer comprises a linear low density polyethylene having a melt index of from 0.8 to 1.5 dg/10 minutes and a density of from 0.91 to 0.92 g/cc. In an embodiment, said skin seal layer consists essentially of the ethylene interpolymer product described in the preceding sentence and in a different embodiment, said skin seal layers consists of 80 to 99 weight % of that ethylene interpolymer product (and from 20 to 1 weight % of one or more additional ethylene polymers).

In an embodiment, there is provided a multilayer stretch film comprising from 3 to 15 layers, said stretch film comprising

1) a first skin layer consisting of from 80 to 100 weight % of an ethylene interpolymer product having a melt index of from 2.5 to 4.5 dg/minute, wherein melt index is measured according to ASTM D 1238 (2.16 kg load and 190° C.) and a density of from 0.905 to 0.914 g/cc, wherein density is measured according to ASTM D792; wherein said ethylene interpolymer product comprises:

(I) a first ethylene interpolymer;

(II) a second ethylene interpolymer, and;

(III) optionally a third ethylene interpolymer;

wherein said first ethylene interpolymer is produced using a single site catalyst formulation comprising a component (i) defined by the formula:

(L^{A})ₐM(Pl)_{b}(Q)ₙ

wherein L^{A} is selected from the group consisting of unsubstituted cyclopentadienyl, substituted cyclopentadienyl, unsubstituted indenyl, substituted indenyl, unsubstituted fluorenyl and substituted fluorenyl;
M is a metal selected from the group consisting of titanium, hafnium and zirconium;
Pl is a phosphinimine ligand;
Q is independently selected from the group consisting of a hydrogen atom, a halogen atom, a C₁₋₁₀ hydrocarbyl radical, a C₁₋₁₀ alkoxy radical and a C₅₋₁₀ aryl oxide radical; wherein each of said hydrocarbyl, alkoxy, and aryl oxide radicals may be unsubstituted or further substituted by a halogen atom, a C₁₋₁₈ alkyl radical, a C₁₋₈ alkoxy radical, a C₆₋₁₀ aryl or aryloxy radical, an amido radical which is unsubstituted or substituted by up to two C₁₋₈ alkyl radicals or a phosphido radical which is unsubstituted or substituted by up to two C₁₋₈ alkyl radicals; wherein a is 1; b is 1; n is 1 or 2; and (a+b+n) is equivalent to the valence of the metal M, and;
wherein said second ethylene interpolymer is produced using a first in-line Ziegler-Natta catalyst formulation;
wherein said third ethylene interpolymer is produced using said first in-line Ziegler-Natta catalyst formulation or a second in-line Ziegler-Natta catalyst formulation, and;
wherein said ethylene interpolymer product has a Dilution Index, Yd, greater than 0; and

2) at least one core layer comprising a linear ethylene copolymer having a density of from 0.910 to 0.935 g/cc and a melt index of from 2 to 6 dg/minute; wherein said multilayer stretch film has a total thickness of from 0.4 to 2.5 mils; haze of less than 5% and gloss of greater than 70%. In an embodiment, said first skin layer consists essentially of the ethylene interpolymer product described in the previous sentence and in a different embodiment, said first skin layer consists of from 80 to 99 weight % of that ethylene interpolymer product (and from 20 to 1 weight % of one or more additional ethylene polymers). In an embodiment, the multilayer stretch film has a haze of from 1 to 2% and a gloss of from 75 to 85%.

### Definition of Terms

The numerical parameters set forth in the following specification and attached claims should be construed in light of the number of reported significant digits and by applying ordinary rounding techniques. The numerical values set forth in the specific examples are reported as precisely as possible. Any numerical values, however, inherently contain certain errors necessarily resulting from the standard deviation found in their respective testing measurements.

It should be understood that any numerical range recited herein is intended to include all sub-ranges subsumed therein. For example, a range of “1 to 10” is intended to include all sub-ranges between and including the recited minimum value of 1 and the recited maximum value of 10; that is, having a minimum value equal to or greater than 1 and a maximum value of equal to or less than 10. Because the disclosed numerical ranges are continuous, they include every value between the minimum and maximum values. Unless expressly indicated otherwise, the various numerical ranges specified in this application are approximations.

All compositional ranges expressed herein are limited in total to and do not exceed 100 percent (volume percent or weight percent) in practice. Where multiple components can be present in a composition, the sum of the maximum amounts of each component can exceed 100 percent, with the understanding that, and as those skilled in the art readily understand, that the amounts of the components actually used will conform to the maximum of 100 percent.

In order to form a more complete understanding of this disclosure the following terms are defined and should be used with the accompanying figures and the description of the various embodiments throughout.

The term “Dilution Index (Y_{d})”, which has dimensions of degrees (°), and the “Dimensionless Modulus (X_{d})” are based on rheological measurements and are fully described in this disclosure.

As used herein, the term “monomer” refers to a small molecule that may chemically react and become chemically bonded with itself or other monomers to form a polymer.

As used herein, the term “α-olefin” is used to describe a monomer having a linear hydrocarbon chain containing from 3 to 20 carbon atoms having a double bond at one end of the chain.

As used herein, the term “ethylene polymer”, refers to macromolecules produced from ethylene monomers and optionally one or more additional monomers, regardless of the specific catalyst or specific process used to make the ethylene polymer. In the polyethylene art, the one or more additional monomers are called “comonomer(s)” and often include α-olefins. The term “homopolymer” refers to a polymer that contains only one type of monomer. Common ethylene polymers include high density polyethylene (HDPE), medium density polyethylene (MDPE), linear low density polyethylene (LLDPE), very low density polyethylene (VLDPE), ultralow density polyethylene (ULDPE), plastomer and elastomers. The term sLLDPE refers to an LLDPE that is prepared with a single site catalyst. The term ethylene polymer also includes polymers produced in a high pressure polymerization processes; non-limiting examples include low density polyethylene (LDPE), ethylene vinyl acetate copolymers (EVA), ethylene alkyl acrylate copolymers, ethylene acrylic acid copolymers and metal salts of ethylene acrylic acid (commonly referred to as ionomers). The term ethylene polymer also includes block copolymers which may include 2 to 4 comonomers. The term ethylene polymer also includes combinations of, or blends of, the ethylene polymers described above. The term linear ethylene copolymer refers to a copolymer of ethylene and at least one α-olefin (as defined above). In an embodiment, the α-olefin is selected from 1-butene, 1-hexene and 1-octene.

The term “ethylene interpolymer” refers to a subset of polymers within the “ethylene polymer” group that excludes polymers produced in high pressure polymerization processes; non-limiting examples of polymers produced in high pressure processes include LDPE and EVA (the latter is a copolymer of ethylene and vinyl acetate).

The term “heterogeneous ethylene interpolymers” refers to a subset of polymers in the ethylene interpolymer group that are produced using a heterogeneous catalyst formulation; non-limiting examples of which include Ziegler-Natta or chromium catalysts.

The term “homogeneous ethylene interpolymer” refers to a subset of polymers in the ethylene interpolymer group that are produced using metallocene or single-site catalysts. Typically, homogeneous ethylene interpolymers have narrow molecular weight distributions, for example gel permeation chromatography (GPC) M_{w}/Mₙ values of less than 2.8; M_{w} and Mₙ refer to weight and number average molecular weights, respectively. In contrast, the M_{w}/Mₙ of heterogeneous ethylene interpolymers are typically greater than the M_{w}/Mₙ of homogeneous ethylene interpolymers. In general, homogeneous ethylene interpolymers also have a narrow comonomer distribution, i.e. each macromolecule within the molecular weight distribution has a similar comonomer content. Frequently, the composition distribution breadth index “CDBI” is used to quantify how the comonomer is distributed within an ethylene interpolymer, as well as to differentiate ethylene interpolymers produced with different catalysts or processes. The “CDBI₅₀” is defined as the percent of ethylene interpolymer whose composition is within 50% of the median comonomer composition; this definition is consistent with that described in U.S. Pat. No. 5,206,075 assigned to Exxon Chemical Patents Inc. The CDBI₅₀ of an ethylene interpolymer can be calculated from TREF curves (Temperature Rising Elution Fractionation); the TREF method is described in Wild, et al., J. Polym. Sci., Part B, Polym. Phys., Vol. 20 (3), pages 441-455. Typically the CDBI₅₀ of homogeneous ethylene interpolymers are greater than about 70%. In contrast, the CDBI₅₀ of α-olefin containing heterogeneous ethylene interpolymers are generally lower than the CDBI₅₀ of homogeneous ethylene interpolymers.

It is well known to those skilled in the art, that homogeneous ethylene interpolymers are frequently further subdivided into “linear homogeneous ethylene interpolymers” and “substantially linear homogeneous ethylene interpolymers”. These two subgroups differ in the amount of long chain branching: more specifically, linear homogeneous ethylene interpolymers have less than about 0.01 long chain branches per 1000 carbon atoms; while substantially linear ethylene interpolymers have greater than about 0.01 to about 3.0 long chain branches per 1000 carbon atoms. A long chain branch is macromolecular in nature, i.e. similar in length to the macromolecule that the long chain branch is attached to. Hereafter, in this disclosure, the term “homogeneous ethylene interpolymer” refers to both linear homogeneous ethylene interpolymers and substantially linear homogeneous ethylene interpolymers.

Herein, the term “polyolefin” includes ethylene polymers and propylene polymers; non-limiting examples of propylene polymers include isotactic, syndiotactic and atactic propylene homopolymers, random propylene copolymers containing at least one comonomer and impact polypropylene copolymers or heterophasic polypropylene copolymers.

The term “thermoplastic” refers to a polymer that becomes liquid when heated, will flow under pressure and solidify when cooled. Thermoplastic polymers include ethylene polymers as well as other polymers commonly used in the plastic industry; non-limiting examples of other polymers commonly used in film applications include barrier resins (EVOH), tie resins, polyethylene terephthalate (PET), polyamides and the like.

As used herein the term “monolayer film” refers to a film containing a single layer of one or more thermoplastics.

As used herein the term “multilayer film” refers to a film comprised of more than one thermoplastic layer, or optionally non-thermoplastic layers. Non-limiting examples of non-thermoplastic materials include metals (foil) or cellulosic (paper) products. One or more of the thermoplastic layers within a multilayer film may be comprised of more than one thermoplastic.

As used herein, the term “tie resin” refers to a thermoplastic that when formed into an intermediate layer, or a “tie layer” within a multilayer film structure, promotes adhesion between adjacent film layers that are dissimilar in chemical composition.

In coextrusions the following nomenclature is typically used to designate a 5-layer coextruded film: A/B/C/D/E; wherein each uppercase letter refers to a chemically distinct layer. The central layer, layer C is typically called the “core layer”; similarly, three layer, seven layer, nine layer and eleven layer films, etc., have a central core layer. In a five layer multilayer film with the structure A/B/C/D/E, layers A and E are typically called the “skin layers” and layers B and D are typically called “intermediate layers”. In the case of a five layer film with the structure A/B/C/B/A; the chemical composition of the two “A” skin layers are identical, similarly the chemical composition of the two intermediate “B” layers are identical.

As used herein, the term “sealant layer” refers to a layer of thermoplastic film that is capable of being attached to a second substrate, forming a leak proof seal.

As used herein, the term “adhesive lamination” and the term “extrusion lamination” describes continuous processes through which two or more substrates, or webs of material, are combined to form a multilayer product or sheet; wherein the two or more webs are joined using an adhesive or a molten thermoplastic film, respectively.

As used herein, the term “extrusion coating” describes a continuous process through which a molten thermoplastic layer is combined with, or deposited on, a moving solid web or substrate. Non-limiting examples of substrates include paper, paperboard, foil, monolayer plastic film, multilayer plastic film or fabric. The molten thermoplastic layer could be monolayer or multilayer.

As used herein, the terms “hydrocarbyl”, “hydrocarbyl radical” or “hydrocarbyl group” refers to linear or cyclic, aliphatic, olefinic, acetylenic and aryl (aromatic) radicals comprising hydrogen and carbon that are deficient by one hydrogen.

As used herein, an “alkyl radical” includes linear, branched and cyclic paraffin radicals that are deficient by one hydrogen radical; non-limiting examples include methyl (—CH₃) and ethyl (—CH₂CH₃) radicals. The term “alkenyl radical” refers to linear, branched and cyclic hydrocarbons containing at least one carbon-carbon double bond that is deficient by one hydrogen radical.

Herein the term “R1” and its superscript form “^{R1}” refers to a first reactor in a continuous solution polymerization process; it being understood that R1 is distinctly different from the symbol R¹; the latter is used in chemical formula, e.g. representing a hydrocarbyl group. Similarly, the term “R2” and it's superscript form “^{R2}” refers to a second reactor, and; the term “R3” and it's superscript form “^{R3}” refers to a third reactor.

### DESCRIPTION OF EMBODIMENTS

### Catalysts

Organometallic catalyst formulations that are efficient in polymerizing olefins are well known in the art. In the embodiments disclosed herein, at least two catalyst formulations are employed in a continuous solution polymerization process. One of the catalyst formulations is a single-site catalyst formulation that produces a first ethylene interpolymer. The other catalyst formulation is a heterogeneous catalyst formulation that produces a second ethylene interpolymer. Optionally a third ethylene interpolymer is produced using the heterogeneous catalyst formulation that was used to produce the second ethylene interpolymer, or a different heterogeneous catalyst formulation may be used to produce the third ethylene interpolymer. In the continuous solution process, the at least one homogeneous ethylene interpolymer and the at least one heterogeneous ethylene interpolymer are solution blended and an ethylene interpolymer product is produced.

### Single Site Catalyst Formulation

The catalyst components which make up the single site catalyst formulation are not particularly limited, i.e. a wide variety of catalyst components can be used.

One non-limiting embodiment of a single site catalyst formulation comprises the following three or four components: a bulky ligand-metal complex; an alumoxane co-catalyst; an ionic activator and optionally a hindered phenol. In Table 2A of this disclosure: “(i)” refers to the amount of “component (i)”, i.e. the bulky ligand-metal complex added to R1; “(ii)” refers to “component (ii)”, i.e. the alumoxane co-catalyst; “(iii)” refers to “component (iii)” i.e. the ionic activator, and; “(iv)” refers to “component (iv)”, i.e. the optional hindered phenol.

Non-limiting examples of component (i) are represented by formula (I):

(L^{A})ₐM(Pl)_{b}(Q)ₙ (I)

wherein (L^{A}) represents a bulky ligand; M represents a metal atom; Pl represents a phosphinimine ligand; Q represents a leaving group; a is 0 or 1; b is 1 or 2; (a+b)=2; n is 1 or 2, and; the sum of (a+b+n) equals the valance of the metal M.

Non-limiting examples of the bulky ligand L^{A} in formula (I) include unsubstituted or substituted cyclopentadienyl ligands or cyclopentadienyl-type ligands, heteroatom substituted and/or heteroatom containing cyclopentadienyl-type ligands. Additional non-limiting examples include, cyclopentaphenanthreneyl ligands, unsubstituted or substituted indenyl ligands, benzindenyl ligands, unsubstituted or substituted fluorenyl ligands, octahydrofluorenyl ligands, cyclooctatetraendiyl ligands, cyclopentacyclododecene ligands, azenyl ligands, azulene ligands, pentalene ligands, phosphoyl ligands, phosphinimine, pyrrolyl ligands, pyrozolyl ligands, carbazolyl ligands, borabenzene ligands and the like, including hydrogenated versions thereof, for example tetrahydroindenyl ligands. In other embodiments, L^{A} may be any other ligand structure capable of n-bonding to the metal M, such embodiments include both η³-bonding and η⁵-bonding to the metal M. In other embodiments, L^{A} may comprise one or more heteroatoms, for example, nitrogen, silicon, boron, germanium, sulfur and phosphorous, in combination with carbon atoms to form an open, acyclic, or a fused ring, or ring system, for example, a heterocyclopentadienyl ancillary ligand. Other non-limiting embodiments for L^{A} include bulky amides, phosphides, alkoxides, aryloxides, imides, carbolides, borollides, porphyrins, phthalocyanines, corrins and other polyazomacrocycles.

Non-limiting examples of metal M in formula (I) include Group 4 metals, titanium, zirconium and hafnium.

The phosphinimine ligand, Pl, is defined by formula (II):

(R^{p})₃P═N— (II)

wherein the R^{p} groups are independently selected from: a hydrogen atom; a halogen atom; C₁₋₂₀ hydrocarbyl radicals which are unsubstituted or substituted with one or more halogen atom(s); a C₁₋₈ alkoxy radical; a C₆₋₁₀ aryl radical; a C₆₋₁₀ aryloxy radical; an amido radical; a silyl radical of formula —Si(R^{s})₃, wherein the R^{s} groups are independently selected from, a hydrogen atom, a C₁₋₈ alkyl or alkoxy radical, a C₆₋₁₀ aryl radical, a C₆₋₁₀ aryloxy radical, or a germanyl radical of formula —Ge(R^{G})₃, wherein the R^{G} groups are defined as R^{s} is defined in this paragraph.

The leaving group Q is any ligand that can be abstracted from formula (I) forming a catalyst species capable of polymerizing one or more olefin(s). An equivalent term for Q is an “activatable ligand”, i.e. equivalent to the term “leaving group”. In some embodiments, Q is a monoanionic labile ligand having a sigma bond to M. Depending on the oxidation state of the metal, the value for n is 1 or 2 such that formula (I) represents a neutral bulky ligand-metal complex. Non-limiting examples of Q ligands include a hydrogen atom, halogens, C₁₋₂₀ hydrocarbyl radicals, C₁₋₂₀ alkoxy radicals, C₅₋₁₀ aryl oxide radicals; these radicals may be linear, branched or cyclic or further substituted by halogen atoms, C₁₋₁₀ alkyl radicals, C₁₋₁₀ alkoxy radicals, C₆₋₁₀ aryl or aryloxy radicals. Further non-limiting examples of Q ligands include weak bases such as amines, phosphines, ethers, carboxylates, dienes, hydrocarbyl radicals having from 1 to 20 carbon atoms. In another embodiment, two Q ligands may form part of a fused ring or ring system.

Further embodiments of component (i) of the single site catalyst formulation include structural, optical or enantiomeric isomers (meso and racemic isomers) and mixtures thereof of the bulky ligand-metal complexes described in formula (I) above.

The second single site catalyst component, component (ii), is an alumoxane co-catalyst that activates component (i) to a cationic complex. An equivalent term for “alumoxane” is “alum inoxane”; although the exact structure of this co-catalyst is uncertain, subject matter experts generally agree that it is an oligomeric species that contain repeating units of the general formula (III):

(R)₂AlO—(Al(R)—O)ₙ—Al(R)₂ (III)

where the R groups may be the same or different linear, branched or cyclic hydrocarbyl radicals containing 1 to 20 carbon atoms and n is from 0 to about 50. A non-limiting example of an alumoxane is methyl alum inoxane (or MAO) wherein each R group in formula (III) is a methyl radical.

The third catalyst component (iii) of the single site catalyst formation is an ionic activator. In general, ionic activators are comprised of a cation and a bulky anion; wherein the latter is substantially non-coordinating. Non-limiting examples of ionic activators are boron ionic activators that are four coordinate with four ligands bonded to the boron atom. Non-limiting examples of boron ionic activators include the following formulas (IV) and (V) shown below;

[R⁵]⁺[B(R⁷)₄]⁻ (IV)

where B represents a boron atom, R⁵ is an aromatic hydrocarbyl (e.g. triphenyl methyl cation) and each R⁷ is independently selected from phenyl radicals which are unsubstituted or substituted with from 3 to 5 substituents selected from fluorine atoms, C₁₋₄ alkyl or alkoxy radicals which are unsubstituted or substituted by fluorine atoms; and a silyl radical of formula —Si(R⁹)₃, where each R⁹ is independently selected from hydrogen atoms and C₁₋₄ alkyl radicals, and; compounds of formula (V);

[(R⁸)ₜZH]⁺[B(R⁷)₄]⁻ (V)

where B is a boron atom, H is a hydrogen atom, Z is a nitrogen or phosphorus atom, t is 2 or 3 and R⁸ is selected from C₁₋₈ alkyl radicals, phenyl radicals which are unsubstituted or substituted by up to three C₁₋₄ alkyl radicals, or one R⁸ taken together with the nitrogen atom may form an anilinium radical and R⁷ is as defined above in formula (IV).

In both formula (IV) and (V), a non-limiting example of R⁷ is a pentafluorophenyl radical. In general, boron ionic activators may be described as salts of tetra(perfluorophenyl) boron; non-limiting examples include anilinium, carbonium, oxonium, phosphonium and sulfonium salts of tetra(perfluorophenyl)boron with anilinium and trityl (or triphenylmethylium). Additional non-limiting examples of ionic activators include: triethylammonium tetra(phenyl)boron, tripropylammonium tetra(phenyl)boron, tri(n-butyl)ammonium tetra(phenyl)boron, trimethylammonium tetra(p-tolyl)boron, trimethylammonium tetra(o-tolyl)boron, tributylammonium tetra(pentafluorophenyl)boron, tripropylammonium tetra(o,p-dimethylphenyl)boron, tributylammonium tetra(m,m-dimethylphenyl)boron, tributylammonium tetra(p-trifluoromethylphenyl)boron, tributylammonium tetra(pentafluorophenyl)boron, tri(n-butyl)ammonium tetra(o-tolyl)boron, N,N-dimethylanilinium tetra(phenyl)boron, N,N-diethylanilinium tetra(phenyl)boron, N,N-diethylanilinium tetra(phenyl)n-butylboron, N,N-2,4,6-pentamethylanilinium tetra(phenyl)boron, di-(isopropyl)ammonium tetra(pentafluorophenyl)boron, dicyclohexylammonium tetra(phenyl)boron, triphenylphosphonium tetra(phenyl)boron, tri(methylphenyl)phosphonium tetra(phenyl)boron, tri(dimethylphenyl)phosphonium tetra(phenyl)boron, tropillium tetrakispentafluorophenyl borate, triphenylmethylium tetrakispentafluorophenyl borate, benzene(diazonium)tetrakispentafluorophenyl borate, tropillium tetrakis(2,3,5,6-tetrafluorophenyl)borate, triphenylmethylium tetrakis(2,3,5,6-tetrafluorophenyl)borate, benzene(diazonium) tetrakis(3,4,5-trifluorophenyl)borate, tropillium tetrakis(3,4,5-trifluorophenyl)borate, benzene(diazonium) tetrakis(3,4,5-trifluorophenyl)borate, tropillium tetrakis(1,2,2-trifluoroethenyl)borate, triphenylmethylium tetrakis(1,2,2-trifluoroethenyl)borate, benzene(diazonium) tetrakis(1,2,2-trifluoroethenyl)borate, tropillium tetrakis(2,3,4,5-tetrafluorophenyl)borate, triphenylmethylium tetrakis(2,3,4,5-tetrafluorophenyl)borate, and benzene(diazonium) tetrakis(2,3,4,5 tetrafluorophenyl)borate. Readily available commercial ionic activators include N,N-dimethylanilinium tetrakispentafluorophenyl borate, and triphenylmethylium tetrakispentafluorophenyl borate.

The optional fourth catalyst component of the single site catalyst formation is a hindered phenol, component (iv). Non-limiting example of hindered phenols include butylated phenolic antioxidants, butylated hydroxytoluene, 2,4-di-tertiarybutyl-6-ethyl phenol, 4,4′-methylenebis (2,6-di-tertiary-butylphenol), 1,3,5-trimethyl-2,4,6-tris (3,5-di-tert-butyl-4-hydroxybenzyl) benzene and octadecyl-3-(3′,5′-di-tert-butyl-4′-hydroxyphenyl) propionate.

To produce an active single site catalyst formulation the quantity and mole ratios of the three or four components (i) through (iv) are optimized as described below.

### Heterogeneous Catalyst Formulations

A number of heterogeneous catalyst formulations are well known to those skilled in the art, including, as non-limiting examples, Ziegler-Natta and chromium catalyst formulations.

In this disclosure, embodiments include an in-line and batch Ziegler-Natta catalyst formulations. The term “in-line Ziegler-Natta catalyst formulation” refers to the continuous synthesis of a small quantity of active Ziegler-Natta catalyst and immediately injecting this catalyst into at least one continuously operating reactor, where the catalyst polymerizes ethylene and one or more optional α-olefins to form an ethylene interpolymer. The terms “batch Ziegler-Natta catalyst formulation” or “batch Ziegler-Natta procatalyst” refer to the synthesis of a much larger quantity of catalyst or procatalyst in one or more mixing vessels that are external to, or isolated from, the continuously operating solution polymerization process. Once prepared, the batch Ziegler-Natta catalyst formulation, or batch Ziegler-Natta procatalyst, is transferred to a catalyst storage tank. The term “procatalyst” refers to an inactive catalyst formulation (inactive with respect to ethylene polymerization); the procatalyst is converted into an active catalyst by adding an alkyl aluminum co-catalyst. As needed, the procatalyst is pumped from the storage tank to at least one continuously operating reactor, where an active catalyst is formed and polymerizes ethylene and one or more optional α-olefins to form an ethylene interpolymer. The procatalyst may be converted into an active catalyst in the reactor or external to the reactor.

A wide variety of chemical compounds can be used to synthesize an active Ziegler-Natta catalyst formulation. The following describes various chemical compounds that may be combined to produce an active Ziegler-Natta catalyst formulation. Those skilled in the art will understand that the embodiments in this disclosure are not limited to the specific chemical compound disclosed.

An active Ziegler-Natta catalyst formulation may be formed from: a magnesium compound, a chloride compound, a metal compound, an alkyl aluminum co-catalyst and an aluminum alkyl. In Table 2A of this disclosure: “(v)” refers to “component (v)” the magnesium compound; the term “(vi)” refers to the “component (vi)” the chloride compound; “(vii)” refers to “component (vii)” the metal compound; “(viii)” refers to “component (viii)” alkyl aluminum co-catalyst, and; “(ix)” refers to “component (ix)” the aluminum alkyl. As will be appreciated by those skilled in the art, Ziegler-Natta catalyst formulations may contain additional components; a non-limiting example of an additional component is an electron donor, e.g. amines or ethers.

A non-limiting example of an active in-line Ziegler-Natta catalyst formulation can be prepared as follows. In the first step, a solution of a magnesium compound (component (v)) is reacted with a solution of the chloride compound (component (vi)) to form a magnesium chloride support suspended in solution. Non-limiting examples of magnesium compounds include Mg(R¹)₂, wherein the R¹ groups may be the same or different, linear, branched or cyclic hydrocarbyl radicals containing 1 to 10 carbon atoms. Non-limiting examples of chloride compounds include R²Cl, wherein R² represents a hydrogen atom, or a linear, branched or cyclic hydrocarbyl radical containing 1 to 10 carbon atoms. In the first step, the solution of magnesium compound may also contain an aluminum alkyl (component (ix)). Non-limiting examples of aluminum alkyl include Al(R³)₃, wherein the R³ groups may be the same or different, linear, branched or cyclic hydrocarbyl radicals containing from 1 to 10 carbon atoms. In the second step a solution of the metal compound (component (vii)) is added to the solution of magnesium chloride and the metal compound is supported on the magnesium chloride. Non-limiting examples of suitable metal compounds include M(X)ₙ or MO(X)ₙ, where M represents a metal selected from Group 4 through Group 8 of the Periodic Table, or mixtures of metals selected from Group 4 through Group 8; 0 represents oxygen, and; X represents chloride or bromide; n is an integer from 3 to 6 that satisfies the oxidation state of the metal. Additional non-limiting examples of suitable metal compounds include Group 4 to Group 8 metal alkyls, metal alkoxides (which may be prepared by reacting a metal alkyl with an alcohol) and mixed-ligand metal compounds that contain a mixture of halide, alkyl and alkoxide ligands. In the third step a solution of an alkyl aluminum co-catalyst (component (viii)) is added to the metal compound supported on the magnesium chloride. A wide variety of alkyl aluminum co-catalysts are suitable, as expressed by formula (VI):

Al(R⁴)ₚ(OR⁵)_{q}(X)ᵣ (VI)

wherein the R⁴ groups may be the same or different, hydrocarbyl groups having from 1 to 10 carbon atoms; the OR⁵ groups may be the same or different, alkoxy or aryloxy groups wherein R⁵ is a hydrocarbyl group having from 1 to 10 carbon atoms bonded to oxygen; X is chloride or bromide, and; (p+q+r)=3, with the proviso that p is greater than 0. Non-limiting examples of commonly used alkyl aluminum co-catalysts include trimethyl aluminum, triethyl aluminum, tributyl aluminum, dimethyl aluminum methoxide, diethyl aluminum ethoxide, dibutyl aluminum butoxide, dimethyl aluminum chloride or bromide, diethyl aluminum chloride or bromide, dibutyl aluminum chloride or bromide and ethyl aluminum dichloride or dibromide.

The process described in the paragraph above, to synthesize an active in-line Ziegler-Natta catalyst formulation, can be carried out in a variety of solvents; non-limiting examples of solvents include linear or branched C₅ to C₁₂ alkanes or mixtures thereof. To produce an active in-line Ziegler-Natta catalyst formulation the quantity and mole ratios of the five components (v) through (ix) are optimized as described below.

Additional embodiments of heterogeneous catalyst formulations include formulations where the “metal compound” is a chromium compound; non-limiting examples include silyl chromate, chromium oxide and chromocene. In some embodiments, the chromium compound is supported on a metal oxide such as silica or alumina. Heterogeneous catalyst formulations containing chromium may also include co-catalysts, non-limiting examples of co-catalysts include trialkylaluminum, alkylaluminoxane and dialkoxyalkylaluminum compounds and the like.

### Solution Polymerization Process: In-Line Heterogeneous Catalyst Formulation

The ethylene interpolymer products disclosed herein, were produced in a continuous solution polymerization process. This solution process has been fully described in Canadian Patent Application No. CA 2,868,640, filed Oct. 21, 2014 and entitled “Solution Polymerization Process”, which is incorporated by reference into this application in its entirety.

Embodiments of this process includes at least two continuously stirred reactors, R1 and R2 and an optional tubular reactor R3. Feeds (solvent, ethylene, at least two catalyst formulations, optional hydrogen and optional α-olefin) are feed to at least two reactor continuously. A single site catalyst formulation is injected into R1 and a first heterogeneous catalyst formation is injected into R2 and optionally R3. Optionally, a second heterogeneous catalyst formulation is injected into R3. The single site catalyst formulation includes an ionic activator (component (iii)), a bulky ligand-metal complex (component (i)), an alumoxane co-catalyst (component (ii)) and an optional hindered phenol (component (iv)), respectively.

R1 and R2 may be operated in series or parallel modes of operation. To be more clear, in series mode 100% of the effluent from R1 flows directly into R2. In parallel mode, R1 and R2 operate independently and the effluents from R1 and R2 are combined downstream of the reactors.

A heterogeneous catalyst formulation is injected into R2. In one embodiment a first in-line Ziegler-Natta catalyst formulation is injected into R2. A first in-line Ziegler-Natta catalyst formation is formed within a first heterogeneous catalyst assembly by optimizing the following molar ratios: (aluminum alkyl)/(magnesium compound) or (ix)/(v); (chloride compound)/(magnesium compound) or (vi)/(v); (alkyl aluminum co-catalyst)/(metal compound) or (viii)/(vii), and; (aluminum alkyl)/(metal compound) or (ix)/(vii); as well as the time these compounds have to react and equilibrate. Within the first heterogeneous catalyst assembly the time between the addition of the chloride compound and the addition of the metal compound (component (vii)) is controlled; hereafter HUT-1 (the first Hold-Up-Time). The time between the addition of component (vii) and the addition of the alkyl aluminum co-catalyst, component (viii), is also controlled; hereafter HUT-2 (the second Hold-Up-Time). In addition, the time between the addition of the alkyl aluminum co-catalyst and the injection of the in-line Ziegler-Natta catalyst formulation into R2 is controlled; hereafter HUT-3 (the third Hold-Up-Time). Optionally, 100% the alkyl aluminum co-catalyst may be injected directly into R2. Optionally, a portion of the alkyl aluminum co-catalyst may be injected into the first heterogeneous catalyst assembly and the remaining portion injected directly into R2. The quantity of in-line heterogeneous catalyst formulation added to R2 is expressed as the parts-per-million (ppm) of metal compound (component (vii)) in the reactor solution, hereafter “R2 (vii) (ppm)”. Injection of the in-line heterogeneous catalyst formulation into R2 produces a second ethylene interpolymer in a second exit stream (exiting R2). Optionally the second exit stream is deactivated by adding a catalyst deactivator. If the second exit stream is not deactivated the second exit stream enters reactor R3. One embodiment of a suitable R3 design is a tubular reactor. Optionally, one or more of the following fresh feeds may be injected into R3: solvent, ethylene, hydrogen, α-olefin and a first or second heterogeneous catalyst formulation; the latter is supplied from a second heterogeneous catalyst assembly. The chemical composition of the first and second heterogeneous catalyst formulations may be the same, or different, i.e. the catalyst components ((v) through (ix)), mole ratios and hold-up-times may differ in the first and second heterogeneous catalyst assemblies. The second heterogeneous catalyst assembly generates an efficient catalyst by optimizing hold-up-times and the molar ratios of the catalyst components.

In reactor R3, a third ethylene interpolymer may, or may not, form. A third ethylene interpolymer will not form if a catalyst deactivator is added upstream of reactor R3. A third ethylene interpolymer will be formed if a catalyst deactivator is added downstream of R3. The optional third ethylene interpolymer may be formed using a variety of operational modes (with the proviso that catalyst deactivator is not added upstream). Non-limiting examples of operational modes include: (a) residual ethylene, residual optional α-olefin and residual active catalyst entering R3 react to form the third ethylene interpolymer; or (b) fresh process solvent, fresh ethylene and optionally fresh α-olefin are added to R3 and the residual active catalyst entering R3 forms the third ethylene interpolymer; or (c) a second in-line heterogeneous catalyst formulation is added to R3 to polymerize residual ethylene and residual optional α-olefin to form the third ethylene interpolymer; or (d) fresh process solvent, ethylene, optional α-olefin and a second in-line heterogeneous catalyst formulation are added to R3 to form the third ethylene interpolymer.

In series mode, R3 produces a third exit stream (the stream exiting R3) containing the first ethylene interpolymer, the second ethylene interpolymer and optionally a third ethylene interpolymer. A catalyst deactivator may be added to the third exit stream producing a deactivated solution; with the proviso a catalyst deactivator is not added if a catalyst deactivator was added upstream of R3.

The deactivated solution passes through a pressure let down device, a heat exchanger and a passivator is added forming a passivated solution. The passivated solution passes through a series of vapor liquid separators and ultimately the ethylene interpolymer product enters polymer recover. Non-limiting examples of polymer recovery operations include one or more gear pump, single screw extruder or twin screw extruder that forces the molten ethylene interpolymer product through a pelletizer.

Embodiments of the manufactured articles disclosed herein, may also be formed from ethylene interpolymer products synthesized using a batch Ziegler-Natta catalyst. Typically, a first batch Ziegler-Natta procatalyst is injected into R2 and the procatalyst is activated within R2 by injecting an alkyl aluminum co-catalyst forming a first batch Ziegler-Natta catalyst. Optionally, a second batch Ziegler-Natta procatalyst is injected into R3.

A variety of solvents may be used as the process solvent; non-limiting examples include linear, branched or cyclic C₅ to C₁₂ alkanes. Non-limiting examples of α-olefins include C₃ to C₁₀ α-olefins.

In the continuous polymerization process, polymerization is terminated by adding a catalyst deactivator. The catalyst deactivator substantially stops the polymerization reaction by changing active catalyst species to inactive forms. Prior to entering the vapor/liquid separator, a passivator or acid scavenger is added to the deactivated solution. Suitable passivators are well known in the art, non-limiting examples include alkali or alkaline earth metal salts of carboxylic acids or hydrotalcites.

In this disclosure, the number of solution reactors is not particularly important; with the proviso that the continuous solution polymerization process comprises at least two reactors that employ at least one single-site catalyst formulation and at least one heterogeneous catalyst formulation.

### First Ethylene Interpolymer

The first ethylene interpolymer is produced with a single-site catalyst formulation. If the optional α-olefin is not added to reactor 1 (R1), then the ethylene interpolymer produced in R1 is an ethylene homopolymer. If an α-olefin is added, the following weight ratio is one parameter to control the density of the first ethylene interpolymer: ((α-olefin)/(ethylene))^{R1}. The symbol “σ¹” refers to the density of the first ethylene interpolymer produced in R1.

Methods to determine the CDBI₅₀ (Composition Distribution Branching Index) of an ethylene interpolymer are well known to those skilled in the art. The CDBI₅₀, expressed as a percent, is defined as the percent of the ethylene interpolymer whose comonomer composition is within 50% of the median comonomer composition. It is also well known to those skilled in the art that the CDBI₅₀ of ethylene interpolymers produced with single-site catalyst formulations are higher relative to the CDBI₅₀ of α-olefin containing ethylene interpolymers produced with heterogeneous catalyst formulations. The upper limit on the CDBI₅₀ of the first ethylene interpolymer (produced with a single-site catalyst formulation) may be about 98%, in other cases about 95% and in still other cases about 90%. The lower limit on the CDBI₅₀ of the first ethylene interpolymer may be about 70%, in other cases about 75% and in still other cases about 80%.

As is well known to those skilled in the art the M_{w}/Mₙ of ethylene interpolymers produced with single site catalyst formulations are lower relative to ethylene interpolymers produced with heterogeneous catalyst formulations. Thus, in the embodiments disclosed, the first ethylene interpolymer has a lower M_{w}/Mₙ relative to the second ethylene interpolymer; where the second ethylene interpolymer is produced with a heterogeneous catalyst formulation. The upper limit on the M_{w}/Mₙ of the first ethylene interpolymer may be about 2.8, in other cases about 2.5 and in still other cases about 2.2. The lower limit on the M_{w}/Mₙ the first ethylene interpolymer may be about 1.7, in other cases about 1.8 and in still other cases about 1.9.

The first ethylene interpolymer contains catalyst residues that reflect the chemical composition of the single-site catalyst formulation used. Those skilled in the art will understand that catalyst residues are typically quantified by the parts per million of metal in the first ethylene interpolymer, where metal refers to the metal in component (i), i.e. the metal in the “bulky ligand-metal complex”; hereafter (and in the claims) this metal will be referred to “metal A”. As recited earlier in this disclosure, non-limiting examples of metal A include Group 4 metals, titanium, zirconium and hafnium. The upper limit on the ppm of metal A in the first ethylene interpolymer may be about 1.0 ppm, in other cases about 0.9 ppm and in still other cases about 0.8 ppm. The lower limit on the ppm of metal A in the first ethylene interpolymer may be about 0.01 ppm, in other cases about 0.1 ppm and in still other cases about 0.2 ppm.

The amount of hydrogen added to R1 can vary over a wide range allowing the continuous solution process to produce first ethylene interpolymers that differ greatly in melt index, hereafter 12¹ (melt index is measured at 190° C. using a 2.16 kg load following the procedures outlined in ASTM D1238). The quantity of hydrogen added to R1 is expressed as the parts-per-million (ppm) of hydrogen in R1 relative to the total mass in reactor R1, hereafter H₂^{R1} (ppm).

The upper limit on the weight percent (wt %) of the first ethylene interpolymer in the ethylene interpolymer product may be about 60 wt %, in other cases about 55 wt % and in still other cases about 50 wt %. The lower limit on the wt % of the first ethylene interpolymer in the ethylene interpolymer product may be about 15 wt %, in other cases about 25 wt % and in still other cases about 30 wt %.

### Second Ethylene Interpolymer

If optional α-olefin is not added to reactor 2 (R2) either by adding fresh α-olefin to R2 (or carried over from R1) then the ethylene interpolymer produced in R2 is an ethylene homopolymer. If an optional α-olefin is present in R2, the following weight ratio is one parameter to control the density of the second ethylene interpolymer produced in R2: ((α-olefin)/(ethylene))^{R2}. Hereafter, the symbol “σ^{2”} refers to the density of the ethylene interpolymer produced in R2.

A heterogeneous catalyst formulation is used to produce the second ethylene interpolymer. If the second ethylene interpolymer contains an α-olefin, the CDBI₅₀ of the second ethylene interpolymer is lower relative to the CDBI₅₀ of the first ethylene interpolymer that was produced with a single-site catalyst formulation. In an embodiment of this disclosure, the upper limit on the CDBI₅₀ of the second ethylene interpolymer (that contains an α-olefin) may be about 70%, in other cases about 65% and in still other cases about 60%. In an embodiment of this disclosure, the lower limit on the CDBI₅₀ of the second ethylene interpolymer (that contains an α-olefin) may be about 45%, in other cases about 50% and in still other cases about 55%. If an α-olefin is not added to the continuous solution polymerization process the second ethylene interpolymer is an ethylene homopolymer. In the case of a homopolymer, which does not contain α-olefin, one can still measure a CDBI₅₀ using TREF. In the case of a homopolymer, the upper limit on the CDBI₅₀ of the second ethylene interpolymer may be about 98%, in other cases about 96% and in still other cases about 95%; and the lower limit on the CDBI₅₀ may be about 88%, in other cases about 89% and in still other cases about 90%. It is well known to those skilled in the art that as the α-olefin content in the second ethylene interpolymer approaches zero, there is a smooth transition between the recited CDBI₅₀ limits for the second ethylene interpolymers (that contain an α-olefin) and the recited CDBI₅₀ limits for the second ethylene interpolymers that are ethylene homopolymers. Typically, the CDBI₅₀ of the first ethylene interpolymer is higher than the CDBI₅₀ of the second ethylene interpolymer.

The M_{w}/Mₙ of second ethylene interpolymer is higher than the M_{w}/Mₙ of the first ethylene interpolymer. The upper limit on the M_{w}/Mₙ of the second ethylene interpolymer may be about 4.4, in other cases about 4.2 and in still other cases about 4.0. The lower limit on the M_{w}/Mₙ of the second ethylene interpolymer may be about 2.2. M_{w}/Mₙ's of 2.2 are observed when the melt index of the second ethylene interpolymer is high, or when the melt index of the ethylene interpolymer product is high, e.g. greater than 10 g/10 minutes. In other cases the lower limit on the M_{w}/Mₙ of the second ethylene interpolymer may be about 2.4 and in still other cases about 2.6.

The second ethylene interpolymer contains catalyst residues that reflect the chemical composition of heterogeneous catalyst formulation. Those skilled in the art with understand that heterogeneous catalyst residues are typically quantified by the parts per million of metal in the second ethylene interpolymer, where the metal refers to the metal originating from component (vii), i.e. the “metal compound”; hereafter (and in the claims) this metal will be referred to as “metal B”. As recited earlier in this disclosure, non-limiting examples of metal B include metals selected from Group 4 through Group 8 of the Periodic Table, or mixtures of metals selected from Group 4 through Group 8. The upper limit on the ppm of metal B in the second ethylene interpolymer may be about 12 ppm, in other cases about 10 ppm and in still other cases about 8 ppm. The lower limit on the ppm of metal B in the second ethylene interpolymer may be about 0.5 ppm, in other cases about 1 ppm and in still other cases about 3 ppm. While not wishing to be bound by any particular theory, in series mode of operation it is believed that the chemical environment within the second reactor deactivates the single site catalyst formulation; or in parallel mode of operation the chemical environment within R2 deactivates the single site catalyst formation.

The amount of hydrogen added to R2 can vary over a wide range which allows the continuous solution process to produce second ethylene interpolymers that differ greatly in melt index, hereafter 12². The quantity of hydrogen added is expressed as the parts-per-million (ppm) of hydrogen in R2 relative to the total mass in reactor R2; hereafter H₂^{R2} (ppm).

The upper limit on the weight percent (wt %) of the second ethylene interpolymer in the ethylene interpolymer product may be about 85 wt %, in other cases about 80 wt % and in still other cases about 70 wt %. The lower limit on the wt % of the second ethylene interpolymer in the ethylene interpolymer product may be about 30 wt %, in other cases about 40 wt % and in still other cases about 50 wt %.

### Third Ethylene Interpolymer

A third ethylene interpolymer is not produced in R3 if a catalyst deactivator is added upstream of R3. If a catalyst deactivator is not added and optional α-olefin is not present then the third ethylene interpolymer produced in R3 is an ethylene homopolymer. If a catalyst deactivator is not added and optional α-olefin is present in R3, the following weight ratio determines the density of the third ethylene interpolymer: ((α-olefin)/(ethylene))^{R3}. In the continuous solution polymerization process ((α-olefin)/(ethylene))^{R3} is one of the control parameter used to produce a third ethylene interpolymer with a desired density. Hereafter, the symbol “σ³” refers to the density of the ethylene interpolymer produced in R3. Optionally, a second heterogeneous catalyst formulation may be added to R3. In other cases (i.e. α-olefin containing ethylene interpolymer products) the upper limit on the CDBI₅₀ of the optional third ethylene interpolymer may be about 65%, in other cases about 60% and in still other cases about 55%. The CDBI₅₀ of an α-olefin containing optional third ethylene interpolymer will be lower than the CDBI₅₀ of the first ethylene interpolymer produced with the single-site catalyst formulation. Typically, the lower limit on the CDBI₅₀ of the optional third ethylene interpolymer (containing an α-olefin) may be about 35%, in other cases about 40% and in still other cases about 45%. If an α-olefin is not added to the continuous solution polymerization process the optional third ethylene interpolymer is an ethylene homopolymer. In the case of an ethylene homopolymer the upper limit on the CDBI₅₀ may be about 98%, in other cases about 96% and in still other cases about 95%; and the lower limit on the CDBI₅₀ may be about 88%, in other cases about 89% and in still other cases about 90%. Typically, the CDBI₅₀ of the first ethylene interpolymer is higher than the CDBI₅₀ of the third ethylene interpolymer and second ethylene interpolymer.

The upper limit on the M_{w}/Mₙ of the optional third ethylene interpolymer may be about 5.0, in other cases about 4.8 and in still other cases about 4.5. The lower limit on the M_{w}/Mₙ of the optional third ethylene interpolymer may be about 2.2, in other cases about 2.4 and in still other cases about 2.6. The M_{w}/Mₙ of the optional third ethylene interpolymer is higher than the M_{w}/Mₙ of the first ethylene interpolymer. When blended together, the second and third ethylene interpolymer have a fourth M_{w}/Mₙ which is not broader than the M_{w}/Mₙ of the second ethylene interpolymer.

The catalyst residues in the optional third ethylene interpolymer reflect the chemical composition of the heterogeneous catalyst formulation(s) used, i.e. the first and optionally a second heterogeneous catalyst formulation. The chemical compositions of the first and second heterogeneous catalyst formulations may be the same or different, for example a first component (vii) and a second component (vii) may be used to synthesize the first and second heterogeneous catalyst formulation. As recited above, “metal B” refers to the metal that originates from the first component (vii). Hereafter, “metal C” refers to the metal that originates from the second component (vii). Metal B and optional metal C may be the same, or different. Non-limiting examples of metal B and metal C include metals selected from Group 4 through Group 8 of the Periodic Table, or mixtures of metals selected from Group 4 through Group 8. The upper limit on the ppm of (metal B+metal C) in the optional third ethylene interpolymer may be about 12 ppm, in other cases about 10 ppm and in still other cases about 8 ppm. The lower limit on the ppm of (metal B+metal C) in the optional third ethylene interpolymer may be about 0.5 ppm, in other cases about 1 ppm and in still other cases about 3 ppm.

Optionally hydrogen may be added to R3. Adjusting the amount of hydrogen in R3, hereafter H₂^{R3} (ppm), allows the continuous solution process to produce third ethylene interpolymers that differ widely in melt index, hereafter 12³.

The upper limit on the weight percent (wt %) of the optional third ethylene interpolymer in the ethylene interpolymer product may be about 30 wt %, in other cases about 25 wt % and in still other cases about 20 wt %. The lower limit on the wt % of the optional third ethylene interpolymer in the ethylene interpolymer product may be 0 wt %, in other cases about 5 wt %, and in still other cases about 10 wt %.

### Ethylene Interpolymer Product

The ethylene interpolymer product used in this invention includes a first ethylene interpolymer made with a single site catalyst and a second ethylene interpolymer made with a heterogeneous catalyst.

The upper limit on the density of the ethylene interpolymer product is less than about 0.92 g/cm³, especially 0.914 g/cm³. The lower limit on the density of the ethylene interpolymer product is about 0.905 g/cc.

The upper limit on the CDBI₅₀ of the ethylene interpolymer product may be about 97%, in other cases about 90% and in still other cases about 85%. An ethylene interpolymer product with a CDBI₅₀ of 97% may result if an α-olefin is not added to the continuous solution polymerization process; in this case, the ethylene interpolymer product is an ethylene homopolymer. The lower limit on the CDBI₅₀ of an ethylene interpolymer may be about 20%, in other cases about 40% and in still other cases about 60%.

The upper limit on the M_{w}/Mₙ of the ethylene interpolymer product may be about 25, in other cases about 15 and in still other cases about 9. The lower limit on the M_{w}/Mₙ of the ethylene interpolymer product may be 2.0, in other cases about 2.2, and in still other cases about 2.4.

The catalyst residues in the ethylene interpolymer product reflect the chemical compositions of: the single-site catalyst formulation employed in R1; the first heterogeneous catalyst formulation employed in R2; and optionally the first or optionally the first and second heterogeneous catalyst formulation employed in R3. In this disclosure, catalyst residues were quantified by measuring the parts per million of catalytic metal in the ethylene interpolymer products. In addition, the elemental quantities (ppm) of magnesium, chlorine and aluminum were quantified. Catalytic metals originate from two or optionally three sources, specifically: 1) “metal A” that originates from component (i) that was used to form the single-site catalyst formulation; (2) “metal B” that originates from the first component (vii) that was used to form the first heterogeneous catalyst formulation; and (3) optionally “metal C” that originates from the second component (vii) that was used to form the optional second heterogeneous catalyst formulation. Metals A, B and C may be the same or different. In this disclosure the term “total catalytic metal” is equivalent to the sum of catalytic metals A+B+C. Further, in this disclosure the terms “first total catalytic metal” and “second total catalyst metal” are used to differentiate between the first ethylene interpolymer product of this disclosure and a comparative “polyethylene composition” that were produced using different catalyst formulations.

The upper limit on the ppm of metal A in the ethylene interpolymer product may be about 0.6 ppm, in other cases about 0.5 ppm and in still other cases about 0.4 ppm. The lower limit on the ppm of metal A in the ethylene interpolymer product may be about 0.001 ppm, in other cases about 0.01 ppm and in still other cases about 0.03 ppm. The upper limit on the ppm of (metal B+metal C) in the ethylene interpolymer product may be about 11 ppm, in other cases about 9 ppm and in still other cases about 7 ppm. The lower limit on the ppm of (metal B+metal C) in the ethylene interpolymer product may be about 0.5 ppm, in other cases about 1 ppm and in still other cases about 3 ppm.

In some embodiments, ethylene interpolymers may be produced where the catalytic metals (metal A, metal B and metal C) are the same metal; a non-limiting example would be titanium. In such embodiments, the ppm of (metal B+metal C) in the ethylene interpolymer product is calculated using equation (VII):

ppm^{(B+C)}=((ppm^{(A+B+C})−(f^{A}×ppm^{A}))/(1−f^{A}) (VII)

where: ppm^{(B+c)} is the calculated ppm of (metal B+metal C) in the ethylene interpolymer product; ppm^{(A+B+C)} is the total ppm of catalyst residue in the ethylene interpolymer product as measured experimentally, i.e. (metal A ppm+metal B ppm+metal C ppm); f^{A} represents the weight fraction of the first ethylene interpolymer in the ethylene interpolymer product, f^{A} may vary from about 0.15 to about 0.6, and; ppm^{A} represents the ppm of metal A in the first ethylene interpolymer. In equation (VII) ppm^{A} is assumed to be 0.35 ppm.

Embodiments of the ethylene interpolymer products disclosed herein have lower catalyst residues relative to the polyethylene polymers described in U.S. Pat. No. 6,277,931. Higher catalyst residues in U.S. Pat. No. 6,277,931 increase the complexity of the continuous solution polymerization process; an example of increased complexity includes additional purification steps to remove catalyst residues from the polymer. In contrast, in the present disclosure, catalyst residues are not removed. In this disclosure, the upper limit on the “total catalytic metal”, i.e. the total ppm of (metal A ppm+metal B ppm+optional metal C ppm) in the ethylene interpolymer product may be about 11 ppm, in other cases about 9 ppm and in still other cases about 7; and the lower limit on the total ppm of catalyst residuals (metal A+metal B+optional metal C) in the ethylene interpolymer product may be about 0.5 ppm, in other cases about 1 ppm and in still other cases about 3 ppm.

The upper limit on melt index of the ethylene interpolymer product is about 4.5 dg/min. The lower limit on the melt index of the ethylene interpolymer product is about 2.5 dg/min.

The remaining materials in Table 4 include a maleic anhydride grafted polyethylene, BYNEL® 41E710, available from DuPont Packaging & Industrial Polymers. BYNEL was used to formulate a tie-layer between the various ethylene interpolymer-like layers of the 9-layer film ethylene interpolymers and Nylon, i.e. ULTRAMID® C40 L 01 available from BASF Corporation.

Table 5 shows the construction of the 9-layer films that were evaluated.

### Dilution Index (Y_{d}) of Ethylene Interpolymer Products

In FIG. 2 the Dilution Index (Y_{d}), having dimensions of ° (degrees)) of an ethylene interpolymer product disclosed herein, as well as comparative ethylene interpolymer products, i.e. Comparative A, D, E and S.

Comparative S was used as the rheological reference in the Dilution Index test protocol. Comparative S is an ethylene interpolymer product comprising an ethylene interpolymer synthesized using an in-line Ziegler-Natta catalyst in one solution reactor, i.e. SCLAIR® FP120-C which is an ethylene/1-octene interpolymer available from NOVA Chemicals Corporation (Calgary, Alberta, Canada). Comparatives D and E are ethylene interpolymer products comprising a first ethylene interpolymer synthesized using a single-site catalyst formation and a second ethylene interpolymer synthesized using a batch Ziegler-Natta catalyst formulation employing a dual reactor solution process, i.e. ELITE® 5100G and ELITE 5400G, respectively, both ethylene/1-octene interpolymers available from The Dow Chemical Company (Midland, Mich., USA). Comparative A (open square, Y_{d}>0 and X_{d}<0) was an ethylene interpolymer product comprising a first and second ethylene interpolymer synthesized using a single-site catalyst formation in a dual reactor solution process, i.e. SURPASS® FPs117-C which is an ethylene/1-octene interpolymer available from NOVA Chemicals Corporation (Calgary, Alberta, Canada).

The following defines the Dilution Index (Y_{d}). In addition to having molecular weights, molecular weight distributions and branching structures, blends of ethylene interpolymers may exhibit a hierarchical structure in the melt phase. In other words, the ethylene interpolymer components may be, or may not be, homogeneous down to the molecular level depending on interpolymer miscibility and the physical history of the blend. Such hierarchical physical structure in the melt is expected to have a strong impact on flow and hence on processing and converting; as well as the end-use properties of manufactured articles. The nature of this hierarchical physical structure between interpolymers can be characterized.

The hierarchical physical structure of ethylene interpolymers can be characterized using melt rheology. A convenient method can be based on the small amplitude frequency sweep tests. Such rheology results are expressed as the phase angle gas a function of complex modulus G*, referred to as van Gurp-Palmen plots (as described in M. Van Gurp, J. Palmen, Rheol. Bull. (1998) 67(1): 5-8, and; Dealy J, Plazek D. Rheol. Bull. (2009) 78(2): 16-31). For a typical ethylene interpolymer, the phase angle δ increases toward its upper bound of 90° with G* becoming sufficiently low. A typical VGP plot is shown in FIG. 3. The VGP plots are a signature of resin architecture. The rise of δ toward 90° is monotonic for an ideally linear, monodisperse interpolymer. The δ(G*) for a branched interpolymer or a blend containing a branched interpolymer may show an inflection point that reflects the topology of the branched interpolymer (see S. Trinkle, P. Walter, C. Friedrich, Rheo. Acta (2002) 41: 103-113). The deviation of the phase angle δ from the monotonic rise may indicate a deviation from the ideal linear interpolymer either due to presence of long chain branching if the inflection point is low (e.g., δ≤20°) or a blend containing at least two interpolymers having dissimilar branching structure if the inflection point is high (e.g., δ≥70°).

For commercially available linear low density polyethylenes, inflection points are not observed; with the exception of some commercial polyethylenes that contain a small amount of long chain branching (LCB). To use the VGP plots regardless of presence of LCB, an alternative is to use the point where the frequency ω_{c} is two decades below the cross-over frequency ω_{c}, i.e., ω_{c}=0.01ωₓ. The cross-over point is taken as the reference as it is known to be a characteristic point that correlates with MI, density and other specifications of an ethylene interpolymer. The cross-over modulus is related to the plateau modulus for a given molecular weight distribution (see S. Wu. J Polym Sci, Polym Phys Ed (1989) 27:723; M. R. Nobile, F. Cocchini. Rheol Acta (2001) 40:111). The two decade shift in phase angle δ is to find the comparable points where the individual viscoelastic responses of constituents could be detected; to be more clear, this two decade shift is shown in FIG. 4. The complex modulus G_{c}* for this point is normalized to the cross-over modulus, Gₓ*/(\sqrt{2}), as (\sqrt{2})G_{c}*/Gₓ*, to minimize the variation due to overall molecular weight, molecular weight distribution and the short chain branching. As a result, the coordinates on VGP plots for this low frequency point at ω_{c}=0.01ωₓ, namely (\sqrt{2})G_{c}*/Gₓ* and δ_{c}, characterize the contribution due to blending. Similar to the inflection points, the closer the ((\sqrt{2})G_{c}*/Gₓ*, δ_{c}) point is toward the 90° upper bound, the more the blend behaves as if it were an ideal single component.

As an alternative way to avoid interference due to the molecular weight, molecular weight distribution and the short branching of the ethylene δ_{c} interpolymer ingredients, the coordinates (G_{c}*, δ_{c}) are compared to a reference sample of interest to form the following two parameters:

Y_{d}=δ_{c}−(C₀−C₁e^{C}^{₂}^{lnG}^{_{c}}^{^{*}}⁾ “Dilution Index (Y_{d})”

X_{d}=log(G_{0.01ω}_{_{c}}*/Gᵣ*) “Dimensionless Modulus (X_{d})”

The constants C₀, C₁, and C₂ are determined by fitting the VGP data δ(G*) of the reference sample to the following equation:

δ=C₀−C₁e^{C}^{₂}^{lnG}^{^{*}}

Gᵣ* is the complex modulus of this reference sample at its δ_{c}=(0.01ωₓ). When an ethylene interpolymer, synthesized with an in-line Ziegler-Natta catalyst employing one solution reactor, having a density of 0.920 g/cm³ and a melt index (MI or 12) of 1.0 dg/min is taken as a reference sample, the constants are:

C₀=93.43°

C₁=1.316°

C₂=0.2945

Gᵣ*=9432 Pa.

The values of these constants can be different if the rheology test protocol differs from that specified herein.

In the Dilution Index testing protocol, the upper limit on Y_{d} may be about 20, in some cases about 15 and is other cases about 13. The lower limit on Y_{d} may be about −30, in some cases −25, in other cases −20 and in still other cases −15.

In the Dilution Index testing protocol, the upper limit on X_{d} is 1.0, in some cases about 0.95 and in other cases about 0.9. The lower limit on X_{d} is −2, in some cases −1.5, and in still other cases −1.0.

### Flexible Manufactured Articles

The ethylene interpolymer products disclosed herein, are well suited for use in films, especially multilayer films.

Depending on the end-use application, the disclosed ethylene interpolymer products may be converted into films that span a wide range of thicknesses. Non-limiting examples include, food packaging films where thicknesses may range from about 0.5 mil (13 μm) to about 4 mil (102 μm); and in heavy duty sack applications film thickness may range from about 2 mil (51 μm) to about 10 mil (254 μm).

The disclosed ethylene interpolymer products may also be used in conventional monolayer films, where the monolayer may contain more than one ethylene interpolymer product and/or additional thermoplastics; non-limiting examples of thermoplastics include ethylene polymers and propylene polymers.

The ethylene interpolymer products disclosed herein may also be used in one or more layers of a multilayer film; non-limiting examples of multilayer films include three, five, seven, nine, eleven or more layers. The thickness of a specific layer (containing an ethylene interpolymer product having improved color) within a multilayer film may be about 1° A, in other cases about 3%, and in still other cases about 5% of the total multilayer film thickness. In other embodiments, the thickness of a specific layer (containing the ethylene interpolymer product having improved color) within a multilayer film may be about 99%, in other cases about 97%, and in still other cases about 95% of the total multilayer film thickness. Each individual layer of a multilayer film may contain more than one ethylene interpolymer product and/or additional thermoplastics. The films may be oriented, especially machine direction oriented (MDO).

Additional embodiments include laminations and coatings, wherein mono or multilayer films containing the disclosed ethylene interpolymer products are extrusion laminated or adhesively laminated or extrusion coated. In extrusion lamination or adhesive lamination, two or more substrates are bonded together with a thermoplastic or an adhesive, respectively. In extrusion coating, a thermoplastic is applied to the surface of a substrate. These processes are well known to those experienced in the art.

Additional non-limiting examples where the disclosed ethylene interpolymer products are useful in monolayer or multilayer films include: fresh and frozen food packaging (including liquids, gels or solids); stand-up pouches; retortable packaging and bag-in-box packaging; barrier films (oxygen, moisture, aroma, oil, etc.) and modified atmosphere packaging; light and heavy duty shrink films and wraps; collation shrink film; pallet shrink film; shrink bag, shrink bundling and shrink shrouds; light and heavy duty stretch films; hand stretch wrap; machine stretch wrap and stretch hood films; high clarity films; heavy-duty sacks; household wrap, overwrap films and sandwich bags; industrial and institutional films, trash bags, can liners, magazine overwrap, newspaper bags, mail bags, sacks and envelopes; bubble wrap, carpet film, furniture bags, garment bags, coin bags, auto panel films; medical applications such as gowns, draping and surgical garb; construction films and sheeting, asphalt films, insulation bags, masking film, landscaping film and bags; geomembrane liners for municipal waste disposal and mining applications; batch inclusion bags; agricultural films, mulch film and green house films; in-store packaging, self-service bags, boutique bags, grocery bags, carry-out sacks and t-shirt bags; oriented films, machine direction and biaxially oriented films and functional film layers in oriented polypropylene (OPP) films, e.g. sealant and/or toughness layers. Additional manufactured articles comprising one or more films containing at least one ethylene interpolymer product having improved color include laminates and/or multilayer films; sealants and tie layers in multilayer films and composites; laminations with paper; aluminum foil laminates or laminates containing vacuum deposited aluminum; polyimide laminates; polyester laminates; extrusion coated laminates, and; hot-melt adhesive formulations. The manufactured articles summarized in this paragraph contain at least one film (monolayer or multilayer) comprising at least one embodiment of the disclosed ethylene interpolymer products.

Desired film physical properties (monolayer or multilayer) typically depend on the application of interest. Non-limiting examples of desirable film properties include: high caulkability, good seal through contamination, good hot tack, low heat sealing initiation, good optical properties (gloss, haze and clarity), dart impact, Elmendorf tear, modulus (1% and 2% secant modulus), puncture-propagation tear resistance and tensile properties (yield strength, break strength, elongation at break, toughness, etc.).

### Additives and Adjuvants

The mono and multilayer films disclosed here, containing at least one layer comprising at least one ethylene interpolymer product may optionally include, depending on its intended use, additives and adjuvants. Non-limiting examples of additives and adjuvants include, anti-blocking agents, antioxidants, heat stabilizers, slip agents, processing aids, anti-static additives, colorants, dyes, filler materials, light stabilizers, heat stabilizers, light absorbers, lubricants, pigments, plasticizers, nucleating agents and combinations thereof. Non-limiting examples of suitable primary antioxidants include IRGANOX® 1010 [CAS Reg. No. 6683-19-8] and IRGANOX 1076 [CAS Reg. No. 2082-79-3]; both available from BASF Corporation, Florham Park, N.J., U.S.A. Non-limiting examples of suitable secondary antioxidants include IRGAFOS® 168 [CAS Reg. No. 31570-04-4], available from BASF Corporation, Florham Park, N.J., U.S.A.; Weston 705 [CAS Reg. No. 939402-02-5], available from Addivant, Danbury Conn., U.S.A. and; DOVERPHOS IGP-11° [CAS Reg. No. 1227937-46-3] available form Dover Chemical Corporation, Dover OH, U.S.A.

### Testing Methods

Prior to testing, each specimen was conditioned for at least 24 hours at 23±2° C. and 50±10% relative humidity and subsequent testing was conducted at 23±2° C. and 50±10% relative humidity. Herein, the term “ASTM conditions” refers to a laboratory that is maintained at 23±2° C. and 50±10% relative humidity; and specimens to be tested were conditioned for at least 24 hours in this laboratory prior to testing. ASTM refers to the American Society for Testing and Materials.

### Density

Ethylene interpolymer product densities were determined using ASTM D792-13 (Nov. 1, 2013).

### Melt Index

Ethylene interpolymer product melt index was determined using ASTM D1238 (Aug. 1, 2013). Melt indexes, I₂, I₆, I₁₀ and I₂₁ were measured at 190° C., using weights of 2.16 kg, 6.48 kg, 10 kg and a 21.6 kg respectively. Herein, the term “stress exponent” or its acronym “S. Ex.”, is defined by the following relationship:

S.Ex.=log(I₆/I₂)/log(6480/2160)

wherein I₆ and I₂ are the melt flow rates measured at 190° C. using 6.48 kg and 2.16 kg loads, respectively. In this disclosure, melt index was expressed using the units of g/10 minutes or g/10 min or dg/minutes or dg/min; these units are equivalent.

### Gel Permeation Chromatography (GPC)

Ethylene interpolymer product molecular weights, Mₙ, M_{w} and M_{z}, as well the as the polydispersity (M_{w}/Mₙ), were determined using ASTM D6474-12 (Dec. 15, 2012). This method illuminates the molecular weight distributions of ethylene interpolymer products by high temperature gel permeation chromatography (GPC). The method uses commercially available polystyrene standards to calibrate the GPC.

### Comonomer Content

The quantity of comonomer in an ethylene interpolymer product was determined by FTIR (Fourier Transform Infrared spectroscopy) according to ASTM D6645-01 (published January 2010).

### Composition Distribution Branching Index (CDBI)

The “Composition Distribution Branching Index” or “CDBI” of the disclosed Examples and Comparative Examples were determined using a crystal-TREF unit commercially available form Polymer Char (Valencia, Spain). The acronym “TREF” refers to Temperature Rising Elution Fractionation. A sample of ethylene interpolymer product (80 to 100 mg) was placed in the reactor of the Polymer Char crystal-TREF unit, the reactor was filled with 35 ml of 1,2,4-trichlorobenzene (TCB), heated to 150° C. and held at this temperature for 2 hours to dissolve the sample. An aliquot of the TCB solution (1.5 mL) was then loaded into the Polymer Char TREF column filled with stainless steel beads and the column was equilibrated for 45 minutes at 110° C. The ethylene interpolymer product was then crystallized from the TCB solution, in the TREF column, by slowly cooling the column from 110° C. to 30° C. using a cooling rate of 0.09° C. per minute. The TREF column was then equilibrated at 30° C. for 30 minutes. The crystallized ethylene interpolymer product was then eluted from the TREF column by passing pure TCB solvent through the column at a flow rate of 0.75 mL/minute as the temperature of the column was slowly increased from 30° C. to 120° C. using a heating rate of 0.25° C. per minute. Using Polymer Char software a TREF distribution curve was generated as the ethylene interpolymer product was eluted from the TREF column, i.e. a TREF distribution curve is a plot of the quantity (or intensity) of ethylene interpolymer eluting from the column as a function of TREF elution temperature. A CDBI₅₀ was calculated from the TREF distribution curve for each ethylene interpolymer product analyzed. The “CDBI₅₀” is defined as the percent of ethylene interpolymer whose composition is within 50% of the median comonomer composition (25% on each side of the median comonomer composition); it is calculated from the TREF composition distribution curve and the normalized cumulative integral of the TREF composition distribution curve. Those skilled in the art will understand that a calibration curve is required to convert a TREF elution temperature to comonomer content, i.e. the amount of comonomer in the ethylene interpolymer fraction that elutes at a specific temperature. The generation of such calibration curves are described in the prior art, e.g. Wild, et al., J. Polym. Sci., Part B, Polym. Phys., Vol. 20 (3), pages 441-455: hereby fully incorporated by reference.

### Dilution Index (Y_{d}) Measurements

A series of small amplitude frequency sweep tests were run on each sample using an Anton Paar MCR501 Rotational Rheometer equipped with the “TruGap™ Parallel Plate measuring system”. A gap of 1.5 mm and a strain amplitude of 10% were used throughout the tests. The frequency sweeps were from 0.05 to 100 rad/s at the intervals of seven points per decade. The test temperatures were 170°, 190°, 210° and 230° C. Master curves at 190° C. were constructed for each sample using the Rheoplus/32 V3.40 software through the Standard TTS (time-temperature superposition) procedure, with both horizontal and vertical shift enabled.

The Y_{d} and X_{d} data generated are summarized in Table 10. The flow properties of the ethylene interpolymer products, e.g., the melt strength and melt flow ratio (MFR) are well characterized by the Dilution Index (Y_{d}) and the Dimensionless Modulus (X_{d}) as detailed below. In both cases, the flow property is a strong function of Y_{d} and X_{d} in addition a dependence on the zero-shear viscosity. For example, the melt strength (hereafter MS) values of the disclosed Examples and the Comparative Examples were found to follow the same equation, confirming that the characteristic VGP point ((\sqrt{2})G_{c}*/Gₓ*, δ_{c}) and the derived regrouped coordinates (X_{d}, Y_{d}) represent the structure well:

MS=a₀₀+a₁₀ log η₀−a₂₀(90−δ_{c})−a₃₀((\sqrt{2})G_{c}*/Gₓ*)−a₄₀(90−δ_{c})((\sqrt{2})G_{c}*/Gₓ*)

where

a₀₀=−33.33; a₁₀=9.529; a₂₀=0.03517; a₃₀=0.894; a₄₀=0.02969

and

r²=0.984 and the average relative standard deviation was 0.85%. Further, this relation can be expressed in terms of the Dilution Index (Y_{d}) and the Dimensionless Modulus (X_{d}):

MS=a₀+a₁ log η₀+a₂Y_{d}+a₃X_{d}+a₄Y_{d}X_{d}

where

a₀=33.34; a₁=9.794; a₂=0.02589; a₃=0.1126; a₄=0.03307

and

r²=0.989 and the average relative standard deviation was 0.89%.

The MFR of the disclosed Examples and the Comparative samples were found to follow a similar equation, further confirming that the dilution parameters Y_{d} and X_{d} show that the flow properties of the disclosed Examples differ from the reference and Comparative Examples:

MFR=b₀−b₁ log η₀−b₂Y_{d}−b₃X_{d}

where

b₀=53.27; b₁=6.107; b₂=1.384; b₃=20.34

and

r²=0.889 and the average relative standard deviation and 3.3%.

Further, the polymerization process and catalyst formulations disclosed herein allow the production of ethylene interpolymer products that can be converted into flexible manufactured articles that have a desired balance of physical properties (i.e. several end-use properties can be balanced (as desired) through multidimensional optimization); relative to comparative polyethylenes of comparable density and melt index.

### Dart Impact

Film dart impact strength was determined using ASTM D1709-09 Method A (May 1, 2009). In this disclosure the dart impact test employed a 1.5 inch (38 mm) diameter hemispherical headed dart.

### Puncture

Film “puncture”, the energy (J/mm) required to break the film was determined using ASTM D5748-95 (originally adopted in 1995, reapproved in 2012).

### Lubricated Puncture

The “lubricated puncture” test was performed as follows: the energy (J/mm) to puncture a film sample was determined using a 0.75-inch (1.9-cm) diameter pear-shaped fluorocarbon coated probe travelling at 10-inch per minute (25.4-cm/minute). ASTM conditions were employed. Prior to testing the specimens, the probe head was manually lubricated with Muko Lubricating Jelly to reduce friction. Muko Lubricating Jelly is a water-soluble personal lubricant available from Cardinal Health Inc., 1000 Tesma Way, Vaughan, ON L4K 5R8 Canada. The probe was mounted in an Instron Model 5 SL Universal Testing Machine and a 1000-N load cell as used. Film samples (1.0 mil (25 μm) thick, 5.5 inch (14 cm) wide and 6 inch (15 cm) long) were mounted in the Instron and punctured.

### Tensile Properties

The following film tensile properties were determined using ASTM D882-12 (Aug. 1, 2012): tensile break strength (MPa), elongation at break (%), tensile yield strength (MPa), tensile elongation at yield (%) and film toughness or total energy to break (ft·lb/in³). Tensile properties were measured in the both the machine direction (MD) and the transverse direction (TD) of the blown films.

### Film Modulus

The secant modulus is a measure of film stiffness. The secant modulus is the slope of a line drawn between two points on the stress-strain curve, i.e. the secant line. The first point on the stress-strain curve is the origin, i.e. the point that corresponds to the origin (the point of zero percent strain and zero stress), and; the second point on the stress-strain curve is the point that corresponds to a strain of 1%; given these two points the 1% secant modulus is calculated and is expressed in terms of force per unit area (MPa). The 2% secant modulus is calculated similarly. This method is used to calculated film modulus because the stress-strain relationship of polyethylene does not follow Hook's law, i.e. the stress-strain behavior of polyethylene is non-linear due to its viscoelastic nature. Secant moduli were measured using a conventional Instron tensile tester equipped with a 200 lbf load cell. Strips of monolayer film samples were cut for testing with following dimensions: 14 inch long, 1 inch wide and 1 mil thick; ensuring that there were no nicks or cuts on the edges of the samples. Film samples were cut in both the machine direction (MD) and the transverse direction (TD) and tested. ASTM conditions were used to condition the samples. The thickness of each film was accurately measured with a hand-held micrometer and entered along with the sample name into the Instron software. Samples were loaded in the Instron with a grip separation of 10 inch and pulled at a rate of 1 inch/min generating the strain-strain curve. The 1% and 2% secant modulus were calculated using the Instron software.

### Flexural Properties

The flexural properties, i.e. flexural secant and tangent modulus and flexural strength were determined using ASTM D790-10 (published in April 2010).

### Puncture-Propagation Tear

Puncture-propagation tear resistance of blown film was determined using ASTM D2582-09 (May 1, 2009). This test measures the resistance of a blown film to snagging, or more precisely, to dynamic puncture and propagation of that puncture resulting in a tear. Puncture-propagation tear resistance was measured in the machine direction (MD) and the transverse direction (TD) of the blown films.

### Elmendorf Tear

Film tear performance was determined by ASTM D1922-09 (May 1, 2009); an equivalent term for tear is “Elmendorf tear”. Film tear was measured in both the machine direction (MD) and the transverse direction (TD) of the blown films.

### Optical Properties

Film optical properties were measured as follows: Haze, ASTM D1003-13 (Nov. 15, 2013), and; Gloss ASTM D2457-13 (Apr. 1, 2013).

### Dynatup Impact

Instrumented impact testing was carried out on a machine called a Dynatup Impact Tester purchased from Illinois Test Works Inc., Santa Barbara, Calif., USA; those skilled in the art frequently call this test the Dynatup impact test. Testing was completed according to the following procedure. Test samples are prepared by cutting about 5 inch (12.7 cm) wide and about 6 inch (15.2 cm) long strips from a roll of blown film; film was about 1 mil thick. Prior to testing, the thickness of each sample was accurately measured with a handheld micrometer and recorded. ASTM conditions were employed. Test samples were mounted in the 9250 Dynatup Impact drop tower/test machine using the pneumatic clamp. Dynatup tup #1, 0.5 inch (1.3 cm) diameter, was attached to the crosshead using the Allen bolt supplied. Prior to testing, the crosshead is raised to a height such that the film impact velocity is 10.9±0.1 ft/s. A weight was added to the crosshead such that: 1) the crosshead slowdown, or tup slowdown, was no more than 20% from the beginning of the test to the point of peak load; and 2) the tup must penetrate through the specimen. If the tup does not penetrate through the film, additional weight is added to the crosshead to increase the striking velocity. During each test the Dynatup Impulse Data Acquisition System Software collected the experimental data (load (lb) versus time). At least 5 film samples are tested and the software reports the following average values: “Dynatup Maximum (Max) Load (lb)”, the highest load measured during the impact test; “Dynatup Total Energy (ft·lb)”, the area under the load curve from the start of the test to the end of the test (puncture of the sample); and “Dynatup Total Energy at Max Load (ft·lb)”, the area under the load curve from the start of the test to the maximum load point.

### Hexane Extractables

Hexane extractables was determined according to the Code of Federal Registration 21 CFR § 177.1520 Para (c) 3.1 and 3.2, wherein the quantity of hexane extractable material in a film is determined gravimetrically. Elaborating, 2.5 grams of 3.5 mil (89 μm) monolayer film was placed in a stainless steel basket, the film and basket were weighed (w′), while in the basket the film was: extracted with n-hexane at 49.5° C. for two hours; dried at 80° C. in a vacuum oven for 2 hours; cooled in a desiccator for 30 minutes; and weighed (we). The percent loss in weight is the percent hexane extractables (w^{C6}): w^{C6}=100×(wⁱ−w^{f})/wⁱ.

### Examples

### Part A: Preparation of Ethylene Interpolymer Products

Ethylene interpolymer products were produced in a continuous solution polymerization pilot plant comprising reactors arranged in a series configuration.

Methylpentane was used as the process solvent (a commercial blend of methylpentane isomers). The volume of the first CSTR reactor (R1) was 3.2 gallons (12 L), the volume of the second CSTR reactor (R2) was 5.8 gallons (22 L) and the volume of the tubular reactor (R3) was 4.8 gallons (18 L). Examples of ethylene interpolymer products were produced using an R1 pressure from about 14 MPa to about 18 MPa; R2 was operated at a lower pressure to facilitate continuous flow from R1 to R2. R1 and R2 were operated in series mode, wherein the first exit stream from R1 flows directly into R2. Both CSTR's were agitated to give conditions in which the reactor contents were well mixed. The process was operated continuously by feeding fresh process solvent, ethylene, 1-octene and hydrogen to the reactors.

The single site catalyst components used were: component (i) cyclopentadienyl tri(tertiary butyl)phosphinimine titanium dichloride, (Cp[(t-Bu)₃PN]TiCl₂), hereafter PIC-1; component (ii) methylaluminoxane (MAO-07); component (iii) trityl tetrakis(pentafluoro-phenyl)borate; and component (iv) 2,6-di-tert-butyl-4-ethylphenol. The single site catalyst component solvents used were methylpentane for components (ii) and (iv) and xylene for components (i) and (iii). The quantity of PIC-1 added to R1, “R1 (i) (ppm)” is shown in Table 2A; to be clear, in Example 2 in Table 2A, the solution in R1 contained 0.12 ppm of component (i), i.e. PIC-1. The mole ratios of the single site catalyst components employed to produce Example 2 were: R1 (ii)/(i) mole ratio=100, i.e. [(MAO-07)/(PIC-1)]; R1 (iv)/(ii) mole ratio=0.0, i.e. [(2,6-di-tert-butyl-4-ethylphenol)/(MAO-07)]; and R1 (iii)/(i) mole ratio=1.1, i.e. [(trityl tetrakis(pentafluoro-phenyl)borate)/(PIC-1)].

The in-line Ziegler-Natta catalyst formulation was prepared from the following components: component (v) butyl ethyl magnesium; component (vi) tertiary butyl chloride; component (vii) titanium tetrachloride; component (viii) diethyl aluminum ethoxide; and component (ix) triethyl aluminum. Methylpentane was used as the catalyst component solvent. The in-line Ziegler-Natta catalyst formulation was prepared using the following steps. In step one, a solution of triethylaluminum and dibutylmagnesium ((triethylaluminum)/(dibutylmagnesium) molar ratio of 20) was combined with a solution of tertiary butyl chloride and allowed to react for about 30 seconds (HUT-1); in step two, a solution of titanium tetrachloride was added to the mixture formed in step one and allowed to react for about 14 seconds (HUT-2); and in step three, the mixture formed in step two was allowed to reactor for an additional 3 seconds (HUT-3) prior to injection into R2. The in-line Ziegler-Natta procatalyst formulation was injected into R2 using process solvent, the flow rate of the catalyst containing solvent was about 49 kg/hr. The in-line Ziegler-Natta catalyst formulation was formed in R2 by injecting a solution of diethyl aluminum ethoxide into R2. The quantity of titanium tetrachloride “R2 (vii) (ppm)” added to reactor 2 (R2) is shown in Table 1; to be clear in Example 1 the solution in R2 contained 5.8 ppm of TiCl₄.

Average residence time of the solvent in a reactor is primarily influenced by the amount of solvent flowing through each reactor and the total amount of solvent flowing through the solution process, the following are representative or typical values for the examples shown in Tables 1: average reactor residence times were: about 61 seconds in R1, about 73 seconds in R2, and about 50 seconds in R3 (the volume of R3 was about 4.8 gallons (18 L)).

Polymerization in the continuous solution polymerization process was terminated by adding a catalyst deactivator to the third exit stream exiting the tubular reactor (R3). The catalyst deactivator used was octanoic acid (caprylic acid), commercially available from P&G Chemicals, Cincinnati, Ohio, U.S.A. The catalyst deactivator was added such that the moles of fatty acid added were 50% of the total molar amount of titanium and aluminum added to the polymerization process; to be clear, the moles of octanoic acid added=0.5×(moles titanium+moles aluminum); this mole ratio was consistently used in all examples.

A two-stage devolitizing process was employed to recover the ethylene interpolymer product from the process solvent, i.e. two vapor/liquid separators were used and the second bottom stream (from the second V/L separator) was passed through a gear pump/pelletizer combination. DHT-4V® (hydrotalcite), supplied by Kyowa Chemical Industry Co. LTD, Tokyo, Japan was used as a passivator, or acid scavenger, in the continuous solution process. A slurry of DHT-4V in process solvent was added prior to the first V/L separator. The molar amount of DHT-4V added was about 10-fold higher than the molar amount of chlorides added to the process; the chlorides added were titanium tetrachloride and tertiary butyl chloride.

Prior to pelletization the ethylene interpolymer product was stabilized by adding about 500 ppm of IRGANOX 1076 (a primary antioxidant) and about 500 ppm of IRGAFOS 168 (a secondary antioxidant), based on weight of the ethylene interpolymer product. Antioxidants were dissolved in process solvent and added between the first and second V/L separators.

TABLE 1
Process Conditions for Part A

| | | Comparative | |
|---|---|---|---|
| Process Parameter | Example 1 | Example 2 | Example 3 |
| R1 Catalyst | PIC-1 | PIC-1 | PIC-1 |
| R2 Catalyst | ZN | ZN | ZN |
| R1 (i) (ppm) | 0.15 | 0.16 | 0.23 |
| R2 (vii) (ppm) | 5.8 | 5.8 | 7.6 |
| Prod. Rate (kg/h) | 68.8 | 80.6 | 86.6 |
| ES1 | 38 | 38 | 45 |
| ES2 | 62 | 62 | 55 |
| O/E | 0.792 | 0.757 | 0.673 |
| OS^{R1} (%) | 94 | 94 | 100 |
| H₂^{R1} (ppm) | 2.46 | 0.80 | 0.50 |
| H₂^{R2} (ppm) | 5.43 | 7.59 | 2.65 |
| Prod. Rate (kg/h) | 68.8 | 68.6 | 86.6 |
| R1 total solution rate (kg/h) | 353.6 | 353.6 | 385.7 |
| R2 total solution rate (kg/h) | 196.4 | 196.4 | 214.3 |
| Total solution rate (kg/h) | 550 | 550 | 600 |
| R1 inlet temp (° C.) | 30 | 30 | 30 |
| R2 inlet temp (° C.) | 30 | 30 | 30 |
| R1 Mean temp (° C.) | 143 | 140 | 160 |
| R2 Mean temp (° C.) | 195 | 188 | 201 |
| Q^{R1} (%) | 88.0 | 81.6 | 88 |
| Q^{R2} (%) | 87.4 | 83.9 | 82.2 |
| Density | 0.911 | 0.911 | 0.913 |
| I₂ | 4.5 | 2.6 | 3.6 |
| S. Ex | 1.21 | 1.20 | 1.22 |
| MFR | 21.7 | 22.3 | 20.3 |
| Mw/Mn | 2.42 | 2.87 | 2.33 |
| Mw | 70,512 | 85,922 | 77,686 |

TSR = total flow rate (kg/hr) of solvent + ethylene + octene
ES1 = % of total ethylene added to first reactor
O/E = total octene/ethylene weight ratio
OS = weight % of total octene added to first reactor
QR1 = % ethylene in R1 converted to polymer
QR2 = % of ethylene in R2 converted to polymer
Polymer production rate (kg/hr) is total polymer produced
MI = melt index, “I₂” (dg/min)
S. Ex = stress exponent
MFR = I₂₁/I₂

### Part B: Dilution Index

Dilution Index (Y_{d}) values for the interpolymer products produced in Part A were calculated using the techniques described above. These techniques are also exemplified in U.S. Pat. Nos. 9,512,282 and 10,035,906.

Dilution index (Y_{d}) values are reported in Table 2; units for Y_{d} are degrees.

The Dilution index of comparative product E is also shown in Table 2/Comparative product E is sold under the trademark ELITE 5400G. It is reported to be made with a single site catalyst and a Z/N catalyst in a dual reactor solution polymerization process and has a Y_{d} of less than zero (−2.91 degrees).

TABLE 2
Dilution Index (Yd) Data

| Product | Density | MI | Yd (degrees) |
|---|---|---|---|
| Example 1 | 0.9106 | 4.5 | 5.0 |
| Example 2 | 0.9109 | 2.6 | 5.3 |
| Example 3 | 0.9129 | 3.6 | 5.2 |
| ELITE 5400G | 0.9161 | 1.0 | −2.91 |

### Part C: Two Layer Seal Structure

An ethylene interpolymer product produced in the manner described in Part A was used as the skin layer in a 9 layer film.

### Preparation of Multilayer Films

Multilayer films were produced on a 9-layer line commercially available from Brampton Engineering (Brampton ON, Canada). The structure of the 9-layer films produced is shown in Table 4. The die technology consisted of a pancake die, FLEXSTACK™ Co-extrusion die (SCD), with flow paths machined onto both sides of a plate, the die tooling diameter was 6.3-inches, in this disclosure a die gap of 85-mil was used consistently, film was produced at a Blow-Up-Ratio (BUR) of 2.5 and the output rate of the line was held constant at 250 lb/hr. The specifications of the nine extruders follow: screws 1.5-in diameter, 30/1 length to diameter ratio, 8-polyethylene screws with single flights and Madddox mixers, 1-Nylon screw, extruders were air cooled, equipped with 20-H.P. motors and all extruders were equipped with gravimetric blenders. The nip and collapsing frame included a Decatex horizontal oscillating haul-off and pearl cooling slats just below the nips. The line was equipped with a turret winder and oscillating slitter knives.

The materials used to prepare the films are summarized in Table 3.

The structure of the films is summarized in Table 4. Table 4 describes the 9 layers using letters A to I. Layers A and I are the external layers and are commonly referred to as “skin layers”. Layers B to H inclusive are commonly referred to as “core layers”. The novel interpolymer product used in the skin layer I (produced in the manner described in Part A) has a melt index, 12, of 4 and a density of 0.912 g/cc. The use of a polyethylene having a melt index of 4 in a skin seal layer is not conventional. The use of a higher molecular weight polyethylene (i.e. having a lower melt index of from about 0.5 to 1.5 g/cc) is common because the higher molecular weight resin is more resistant to failures caused by burn through of the seal layer. We have observed that the use of this interpolymer product produces excellent seals. While not wishing to be bound by theory, it is believed that the combination of high melt flow index and low density allows the sealing layer to melt and flow easily, thereby providing a comprehensive coating of the sealant resin in the seal area. Table 4 also shows that layers G and H are made from a linear low density polyethylene having a lower melt index (of 1) and a higher density (0.916 g/cc). Although these layers are reported separately (i.e. as layers G and H, each having a thickness of 0.39 mils), they may also be regarded as a single layer having a total thickness of 0.78 mils.

As noted above, this film has been observed to provide excellent seals. While not wishing to be bound by theory, we believe that layer H (or layers G and H together) provide a second sealant layer in the event that the primary seal layer (i.e. skin layer I) partially fails during the heat sealing process. Thus, the multilayer film shown in Table 4 is described as having a two layer seal structure, with the primary seal layer (the skin layer) being made from an ethylene interpolymer product of this disclosure and the second seal layer being made from a conventional LLDPE sealant having a lower melt index and higher density.

The film structure shown in Table 4 contains two layers of polyamide (skin layer A and core layer E). This was done for experimental purposes because it allows very high heat sealing temperatures to be used—which, in turn, provides a very severe test for the two layer sealant structure. It will be recognized by those skilled in the art that those layers of polyamide may be replaced with other conventional polyethylene products to allow the manufacture of a recyclable film. In addition, the use of EVOH in a core layer (especially in an amount of from 3 to 10%) may be used to improve the barrier performance of the multilayer film in accordance with the common general knowledge of persons skilled in the art of preparing multilayer films for flexible packaging

TABLE 3
Material Description

| | | | Density | I₂ |
|---|---|---|---|---|
| Material | Description | Supplier | (g/cm3) | (g/10 min) |
| 5034B | high viscosity Polyamide 6 | UBE | 1.14 | |
| | homopolymer | | | |
| EVAL | EVAL ™ EVOH (ethylene vinyl- | Kurary | 1.19 | 1.6 |
| F171B | alcohol copolymer)-32 mol % | | | |
| | Ethylene content | | | |
| BYNEL | anhydride-modified linear low- | DuPont | 0.91 | 2.7 |
| 41E710 | density PE (LLDPE) 4100 series | | | |
| EXCEED | Metallocene ethylene-hexene | ExxonMobil | 0.912 | 3.8 |
| 3812 | PE | | | |
| FPs016 | Octene/LLDPE -Film Extrusion | NOVA Chemicals | 0.96 | 1 |
| | grade | | | |
| FP120-A | Octene Copolymer LLDPE Film | NOVA Chemicals | 0.92 | 1 |
| | Resins | | | |
| FPs317 | Octene Copolymer sLLDPE Film | NOVA Chemicals | 0.917 | 4 |
| | Resin | | | |
| FG220-A | Octene Copolymer LLDPE Film | NOVA Chemicals | 0.92 | 2.3 |
| | Resins | | | |
| TF-0219-E | Hexene Copolymer LLDPE Film | NOVA Chemicals | 0.918 | 2 |
| | Resin | | | |
| 412 | Octene Copolymer VLLDPE | NOVA Chemicals | 0.912 | 4 |
| | Film Resins | this disclosure | | |
| | | (experimental) | | |

TABLE 4
Two Layer Seal Structure

| Layer | Polymer | Layer thickness (%) | Layer thickness (mil) |
|---|---|---|---|
| A | 5034B | 11 | 0.39 |
| B | FP016C/BYNEL | 11 | 0.39 |
| C | FP016 | 11 | 0.39 |
| D | FP016C/BYNEL | 11 | 0.39 |
| E | 5034B | 12 | 0.42 |
| F | FP016C/BYNEL | 11 | 0.39 |
| G | FP016C | 11 | 0.39 |
| H | FP016C | 11 | 0.39 |
| I | 412 | 11 | 0.39 |

### Part D: Cast Stretch Film

The ethylene interpolymer product from Example 2 of Part A was used to prepare cast stretch films.

The films were prepared on a three layer cast extrusion line (layers A/B/C) but all three layers were prepared with the same resin which has a melt index of 2.7 dg/min; a density of 0.910 g/cc and a dilution index, Y_{d}, of about 5. A first film having a thickness of 0.8 mils and a second film having a thickness of 2 mils were prepared. Stretch films are commonly used as an overwrap for goods that are shipped on pallets.

The cast stretch films of this example were observed to provide excellent “cling” even though they were made without a cling additive. In addition, the films provide a highly desirable balance of optical and physical properties. The optical properties are particularly outstanding, with gloss of greater than 80% and haze of less than 3% being observed.

In an embodiment, an ethylene interpolymer product having an 12 from 2.5 to 4.5; a density from 0.905 to 0.914 g/cc; and a dilution index greater than 0° is used in at least one skin layer (preferably both skin layers) of multilayer cast films. The combined weight of the skin layer(s) can be made from 20 to 40 weight % of the total amount of polymer used to prepare the film. In an embodiment, the core is also made from polyethylene, especially linear ethylene copolymers having a melt index of from 0.910 to 0.935 g/cc (especially from 0.916 to 0.918 g/cc) and a melt index, 12, of from 2 to 6 dg/minute.

### INDUSTRIAL APPLICABILITY

Multilayer films having two layers that cooperate to provide superior seals. The films are suitable for the preparation of heat-sealed packages.

1. A multilayer film having from 3 to 15 layers, said film having a two layer seal structure comprising a skin seal layer and an adjacent seal layer, wherein said skin seal layer comprises ethylene interpolymer product having a melt index of from 2.5 to 4.5 dg/minute, wherein melt index is measured according to ASTM D 1238 (2.16 kg load and 190° C.) and a density of from 0.91 to 0.914 g/cc, wherein density is measured according to ASTM D792; wherein said ethylene interpolymer product comprises:
(I) a first ethylene interpolymer;
(II) a second ethylene interpolymer, and;
(III) optionally a third ethylene interpolymer;
wherein said first ethylene interpolymer is produced using a single site catalyst formulation comprising a component (i) defined by the formula
(L^{A})ₐM(Pl)_{b}(Q)ₙ
wherein L^{A} is selected from the group consisting of unsubstituted cyclopentadienyl, substituted cyclopentadienyl, unsubstituted indenyl, substituted indenyl, unsubstituted fluorenyl and substituted fluorenyl;
M is a metal selected from the group consisting of titanium, hafnium and zirconium;
Pl is a phosphinimine ligand;
Q is independently selected from the group consisting of a hydrogen atom, a halogen atom, a C₁₋₁₀ hydrocarbyl radical, a C₁₋₁₀ alkoxy radical and a C₅₋₁₀ aryl oxide radical; wherein each of said hydrocarbyl, alkoxy, and aryl oxide radicals may be unsubstituted or further substituted by a halogen atom, a C₁₋₁₈ alkyl radical, a C₁₋₈ alkoxy radical, a C₆₋₁₀ aryl or aryloxy radical, an amido radical which is unsubstituted or substituted by up to two C₁₋₈ alkyl radicals or a phosphido radical which is unsubstituted or substituted by up to two C₁₋₈ alkyl radicals;
wherein a is 1; b is 1; n is 1 or 2; and (a+b+n) is equivalent to the valence of the metal M, and;
wherein said second ethylene interpolymer is produced using a first in-line Ziegler-Natta catalyst formulation;
wherein said third ethylene interpolymer is produced using said first in-line Ziegler-Natta catalyst formulation or a second in-line Ziegler-Natta catalyst formulation, and;
wherein said ethylene interpolymer product has a Dilution Index, Y_{d}, greater than 0, and wherein said adjacent seal layer comprises a linear low density polyethylene having a melt index of from about 0.8 to 1.5 dg/10 minutes and a density of from 0.905 to 0.92 g/cc.

2. The multilayer film of claim 1, wherein said skin seal layer has a density of from 0.905 to 0.914 g/cc and said adjacent seal layer has a density of from 0.915 to 0.919 g/cc.

3. The multilayer film of claim 1, wherein said single site catalyst formulation further comprises: an alumoxane co-catalyst; a boron ionic activator, and; optionally a hindered phenol.

4. The multilayer film of claim 3, wherein said alumoxane co-catalyst is methylalumoxane (MAO) and said boron ionic activator is trityl tetrakis (pentafluoro-phenyl) borate.

5. The multilayer film of claim 1, wherein said ethylene interpolymer product is further characterized as having ≥3 parts per million (ppm) of a total catalytic metal.

6. The multilayer film of claim 1, wherein said ethylene interpolymer product has ≤1 part per million (ppm) of a metal A; wherein said metal A originates from said component (i).

7. The multilayer film of claim 1, wherein said ethylene interpolymer product contains a metal B and optionally a metal C and the total amount of said metal B plus said metal C is from about 3 to about 11 parts per million; wherein said metal B originates from said first in-line Ziegler-Natta catalyst formulation and said metal C originates from said second in-line Ziegler-Natta catalyst formulation; optionally said metal B and said metal C are the same metal.

8. The multilayer film of claim 1, wherein (I) said first ethylene interpolymer has a first CDBI₅₀ from about 70 to about 98%; (II) said second ethylene interpolymer has a second CDBI₅₀ from about 45 to about 98%; and (III) said optional third ethylene interpolymer has a third CDBI₅₀ from about 35 to about 98%.

9. A multilayer stretch film comprising from 3 to 15 layers, said stretch film comprising:
1) a first skin layer comprising an ethylene interpolymer product having a melt index of from 2.5 to 4.5 dg/minute, wherein melt index is measured according to ASTM D 1238 (2.16 kg load and 190° C.) and a density of from 0.905 to 0.914 g/cc, wherein density is measured according to ASTM D792; wherein said ethylene interpolymer product comprises:
(I) a first ethylene interpolymer;
(II) a second ethylene interpolymer, and;
(III) optionally a third ethylene interpolymer;
wherein said first ethylene interpolymer is produced using a single site catalyst formulation comprising a component (i) defined by the formula:
(L^{A})ₐM(Pl)_{b}(Q)ₙ
wherein L^{A} is selected from the group consisting of unsubstituted cyclopentadienyl, substituted cyclopentadienyl, unsubstituted indenyl, substituted indenyl, unsubstituted fluorenyl and substituted fluorenyl;
M is a metal selected from the group consisting of titanium, hafnium, and zirconium;
Pl is a phosphinimine ligand;
Q is independently selected from the group consisting of a hydrogen atom, a halogen atom, a C₁₋₁₀ hydrocarbyl radical, a C₁₋₁₀ alkoxy radical and a C₅₋₁₀ aryl oxide radical; wherein each of said hydrocarbyl, alkoxy, and aryl oxide radicals may be unsubstituted or further substituted by a halogen atom, a C₁₋₁₈ alkyl radical, a C₁₋₈ alkoxy radical, a C₆₋₁₀ aryl or aryloxy radical, an amido radical which is unsubstituted or substituted by up to two C₁₋₈ alkyl radicals or a phosphido radical which is unsubstituted or substituted by up to two C₁₋₈ alkyl radicals;
wherein a is 1; b is 1; n is 1 or 2; and (a+b+n) is equivalent to the valence of the metal M, and;
wherein said second ethylene interpolymer is produced using a first in-line Ziegler-Natta catalyst formulation;
wherein said third ethylene interpolymer is produced using said first in-line Ziegler-Natta catalyst formulation or a second in-line Ziegler-Natta catalyst formulation, and;
wherein said ethylene interpolymer product has a Dilution Index, Y_{d}, greater than 0; and
2) at least one core layer comprising a linear ethylene copolymer having a density of from 0.905 to 0.935 g/cc and a melt index of from 2 to 6 dg/minute; wherein said multilayer stretch film has a total thickness of from 0.4 to 2.5 mils; haze of less than 5% and gloss of greater than 70%.

10. The multilayer stretch film of claim 9 having a haze of from 1 to 2% and a gloss of from 75% to 85%.

11. The multilayer stretch film of claim 9, wherein said single site catalyst formulation further comprises: an alumoxane co-catalyst; a boron ionic activator, and; optionally a hindered phenol.

12. The multilayer stretch film of claim 11, wherein said alumoxane co-catalyst is methylalumoxane (MAO) and said boron ionic activator is trityl tetrakis (pentafluoro-phenyl) borate.

13. The multilayer stretch film of claim 9, wherein said ethylene interpolymer product is further characterized as having ≥3 parts per million (ppm) of a total catalytic metal.

14. The multilayer stretch film of claim 9, wherein said ethylene interpolymer product has ≤1 part per million (ppm) of a metal A; wherein said metal A originates from said component (i).

15. The multilayer stretch film of claim 9, wherein said ethylene interpolymer product contains a metal B and optionally a metal C and the total amount of said metal B plus said metal C is from about 3 to about 11 parts per million; wherein said metal B originates from said first in-line Ziegler-Natta catalyst formulation and said metal C originates from said second in-line Ziegler-Natta catalyst formulation; optionally said metal B and said metal C are the same metal.

16. The multilayer stretch film of claim 9, wherein (I) said first ethylene interpolymer has a first CDBI₅₀ from about 70 to about 98%; (II) said second ethylene interpolymer has a second CDBI₅₀ from about 45 to about 98%; and (III) said optional third ethylene interpolymer has a third CDBI₅₀ from about 35 to about 98%.
